(19) United States
(12) Patent Application Publication
(10) Pub. No.: US 2025/0167837 A1
(43) Pub. Date: May 22, 2025

(54) METHOD AND APPARATUS FOR SECURITY ENHANCEMENT VIA RIS-INDUCED EAVESDROPPER INTERFERENCE

(71) Applicant: ELECTRONICS AND TELECOMMUNICATIONS RESEARCH INSTITUTE, Daejeon (KR)

(72) Inventors: Satya CHAN, Daejeon (KR); Hee Wook KIM, Daejeon (KR); Dae Sub OH, Daejeon (KR)

(73) Assignee: ELECTRONICS AND TELECOMMUNICATIONS RESEARCH INSTITUTE, Daejeon (KR)

(21) Appl. No.: 18/952,488

(22) Filed: Nov. 19, 2024

(30) Foreign Application Priority Data
Nov. 21, 2023 (KR) 10-2023-0162807
Oct. 30, 2024 (KR) 10-2024-0150963

(51) Int. Cl. H04B 7/04; H04L 5/00; H04L 25/02

(52) U.S. Cl. CPC H04B 7/04013; H04L 5/0048; H04L 25/0202

(57) ABSTRACT

A security enhancement method, performed by a controller controlling a reconfigurable intelligent surface (RIS), may comprise: selecting first RIS elements for a first signal transmitted between a transmitter and a first receiver that is a legitimate receiver, the first RIS elements including at least part of elements of the RIS; transmitting the first signal to the first receiver using the first RIS elements; and dynamically rendering a channel with another receiver or an eavesdropper without changing a channel with the first receiver during a channel coherence time between the transmitter and the first receiver, by changing phase(s) of at least part of the first RIS elements at least once during the channel coherence time.

### CROSS-REFERENCE TO RELATED APPLICATIONS

This application claims priority to Korean Patent Applications No. 10-2023-0162807, filed on Nov. 21, 2023, and No. 10-2024-0150963, filed on Oct. 30, 2024, with the Korean Intellectual Property Office (KIPO), the entire contents of which are hereby incorporated by reference.

### BACKGROUND

### 1. Technical Field

The present disclosure relates to a security technique for wireless communication systems, and more particularly, to a method and an apparatus for enhancing physical layer security (PLS) for a wireless network in a wireless communication system including a reconfigurable intelligent surface (RIS).

### 2. Related Art

In modern mobile communications, numerous devices, especially Internet of Things (IoT) devices, are connected to the Internet through terrestrial networks (TN), such as cellular networks, and non-terrestrial networks (NTN), such as low Earth orbit (LEO) satellite systems. The LEO satellite systems serve as essential solutions in remote areas where terrestrial networks cannot reach. These advancements in mobile communications offer a promising solution for enabling widespread Internet connectivity.

As the number of devices connecting to wireless networks continues to grow, the importance of security is increasing. Encryption is essential for protecting information in various applications. However, due to the complexity of encryption and high computational requirements, it poses challenges, especially for resource-constrained devices.

In recent years, physical layer security (PLS) of wireless networks has gained significant attention. Various research efforts have been made to optimize a signal strength for legitimate receivers while minimizing it for eavesdroppers. These efforts include the use of artificial noise (AN)-assisted schemes and signal jamming techniques. Nevertheless, AN-assisted schemes often require additional power, leading to power inefficiency and increased signal fluctuation. On the other hand, signal jamming techniques require dedicated jamming devices and extra power to transmit jamming signals.

A reconfigurable intelligent surface (RIS) is a software-controlled meta-surface that supports the dynamic configuration of wireless channels. RIS technology is known for its cost efficiency and low power consumption and is emerging as a pioneering concept in signal transmission design. RIS is also commonly referred to as an intelligent reflecting surface (IRS). In the present disclosure, RIS and IRS are used interchangeably.

Accordingly, there is a demand for new solutions that can enhance both transmission capacity and security by utilizing RIS.

### SUMMARY

The present disclosure for resolving the above-described problems is directed to providing a method and apparatus for enhancing security of wireless communications, including terrestrial network (TN) and non-terrestrial network (NTN) communication, without imposing additional burdens on wireless platforms such as satellites, base stations, gateways, terminals, or user equipment (UE).

The present disclosure for resolving the above-described problems is also directed to providing a method and apparatus for enhancing security that can disrupt operations of eavesdroppers more economically and efficiently, unlike conventional security techniques that simply use artificial noise (AN) or signal jamming, by utilizing low-cost hardware of a reconfigurable intelligent surface (IRS).

The present disclosure for resolving the above-described problems is also directed to providing a method and apparatus for enhancing security, designed to operate independently of prior knowledge of an eavesdropper's channel, thereby eliminating constraints related to the number of eavesdroppers or eavesdropping antennas.

A security enhancement method performed by a controller controlling a reconfigurable intelligent surface (RIS), according to an exemplary of the present disclosure for resolving the above-described technical problems, may comprise: selecting first RIS elements for a first signal transmitted between a transmitter and a first receiver that is a legitimate receiver, the first RIS elements including at least part of elements of the RIS; transmitting the first signal to the first receiver using the first RIS elements; and dynamically rendering a channel with another receiver or an eavesdropper without changing a channel with the first receiver during a channel coherence time between the transmitter and the first receiver, by changing phase(s) of at least part of the first RIS elements at least once during the channel coherence time.

The first signal may include reference signals or pilot signals for channel estimation.

An interval of the reference signals or pilot signals may be set to be smaller than the channel coherence time for the first signal.

The security enhancement method may further comprise: estimating a channel capacity of the first RIS elements, wherein the estimated channel capacity may be a maximum channel capacity of the first RIS elements.

The security enhancement method may further comprise: determining a channel capacity to be actually used for the first RIS elements by multiplying the maximum channel capacity by a weight having a positive real value less than 1.

The weight may be selected as a value equal to or greater than 0.5 and equal to or less than 0.9.

The maximum channel capacity may be determined based on an optimum accumulated channel from the transmitter to the first receiver.

The security enhancement method may further comprise: determining an accumulated channel with multiple roots from the transmitter to the first receiver.

The rendering may be performed at least once during a reception duration of the first signal, when the first receiver operates for the channel estimation.

The security enhancement method may further comprise: estimating a channel capacity of the first RIS elements, wherein the channel capacity may be estimated as a channel capacity when an inverse bandwidth of a baseband signal at the first receiver is equal to or less than a half of the channel coherence time.

A security enhancement device using a reconfigurable intelligent surface (RIS), according to another exemplary of the present disclosure for resolving the above-described technical problems, may comprise: a memory storing at least one instruction; and a processor executing the at least one instruction, wherein the at least one instruction may cause the processor to perform: selecting first RIS elements for a first signal transmitted between a transmitter and a first receiver that is a legitimate receiver, the first RIS elements including at least part of elements of the RIS; transmitting the first signal to the first receiver using the first RIS elements; and dynamically rendering a channel with another receiver or an eavesdropper without changing a channel with the first receiver during a channel coherence time between the transmitter and the first receiver, by changing phase(s) of at least part of the first RIS elements at least once during the channel coherence time.

The first signal may include reference signals or pilot signals for channel estimation.

An interval of the reference signals or pilot signals may be set to be smaller than the channel coherence time for the first signal.

At least one instruction may cause the processor to perform: estimating a channel capacity of the first RIS elements, wherein the estimated channel capacity may be a maximum channel capacity of the first RIS elements.

At least one instruction may cause the processor to perform: determining a channel capacity to be actually used for the first RIS elements by multiplying the maximum channel capacity by a weight having a positive real value less than 1.

The weight may be selected as a value equal to or greater than 0.5 and equal to or less than 0.9.

The maximum channel capacity may be determined based on an optimum accumulated channel from the transmitter to the first receiver.

At least one instruction may cause the processor to perform: determining an accumulated channel with multiple roots from the transmitter to the first receiver.

The rendering may be performed at least once during a reception duration of the first signal, when the first receiver operates for the channel estimation.

At least one instruction may cause the processor to perform: estimating a channel capacity of the first RIS elements, wherein the channel capacity may be estimated as a channel capacity when an inverse bandwidth of a baseband signal at the first receiver is equal to or less than a half of the channel coherence time.

According to the present disclosure, unlike the conventional security techniques that simply use artificial noise (AN) or signal jamming, a security enhancement method and apparatus can be provided that more economically and efficiently disrupt eavesdropper activities by utilizing a reconfigurable intelligent surface (RIS) with low-cost hardware.

In other words, to accurately estimate a channel at a terminal or receiver, it is essential for the channel to remain stable during an interval of reference signals or pilot signals for channel estimation. Furthermore, to enable proper information detection, the channel needs to remain unchanged for a duration of subsequent signal reception until the next reference signal is received. Considering that the interval between reference signals or pilot signals need to be set smaller than a channel coherence time, a constant channel between a legitimate receiver and the RIS may be maintained during a specific period (i.e. the channel coherence time). Simultaneously, a channel between an eavesdropper and the RIS is intentionally made dynamic throughout the channel coherence time. Thus, according to the present disclosure, overall security can be enhanced by negatively impacting the eavesdropper's signal reception performance without impairing the channel estimation and signal detection capabilities of the legitimate receiver.

Furthermore, according to the present disclosure, a new security enhancement technique can be provided for wireless communication systems, particularly LEO satellite systems, that operates independently of prior knowledge of the eavesdropper's channel. This removes constraints related to the number of eavesdroppers or the number of eavesdropping antennas.

### BRIEF DESCRIPTION OF DRAWINGS

FIG. 1 is a conceptual diagram illustrating a non-terrestrial network to which a security enhancement method according to an exemplary embodiment of the present disclosure is applicable.

FIG. 2 is a conceptual diagram illustrating another non-terrestrial network to which a security enhancement method according to an exemplary embodiment of the present disclosure is applicable.

FIG. 3 is an exemplary diagram of a system model for describing an artificial noise (AN)-aided Alamouti code applicable to a security enhancement technique of the present disclosure.

FIG. 4 is an exemplary diagram of a system model for describing an operational concept of a signal-dependent complex AN, which complements the system mode of FIG. 3.

FIG. 5 is an exemplary diagram of a system model for an RIS-aided system applicable to a security enhancement technique of the present disclosure.

FIG. 6 is a block diagram illustrating configuration of a device applicable to a security enhancement device connected to the RIS in FIG. 5.

FIG. 7 is a schematic block diagram of functional modules applicable to a security enhancement device of FIG. 6.

FIG. 8 is a graph illustrating a comparison of secrecy capacity performance between the system model of FIG. 5 and a comparative example.

FIG. 9 is an exemplary diagram of a system model for describing physical layer security (PLS) using a power-balanced (PB) Alamouti code in an LEO satellite system to which a security enhancement method of the present disclosure is applicable.

FIG. 10 is an exemplary diagram of a system model for describing RIS-aided interference-invoking PLS in a LEO satellite system to which a security enhancement method of the present disclosure is applicable.

FIG. 11 is an exemplary diagram of a system model for describing PLS using a PB-Alamouti code and RIS based on the integrated manner in a LEO satellite system to which a security enhancement method of the present disclosure is applicable.

FIG. 12 is an exemplary diagram of a system model for describing a relay-based PB-Alamouti code for a LEO satellite system to which a security enhancement method of the present disclosure is applicable.

FIG. 13 is a graph comparing a secrecy capacity (SC) between the AN-aided scheme and the PB-Alamouti code scheme in the first exemplary embodiment of the present disclosure.

FIG. 14 is a graph comparing a secrecy rate (SR) between the AN-aided scheme and the PB-Alamouti code scheme in the first exemplary embodiment of the present disclosure.

FIG. 15 is a graph illustrating a secrecy capacity of the RIS-aided scheme according to the second exemplary embodiment of the present disclosure, based on a predetermined range of factor values.

FIG. 16 is a graph illustrating a secrecy rate of the RIS-aided scheme according to the second exemplary embodiment of the present disclosure, based on a predetermined range of factor values.

FIG. 17 is a graph comparing secrecy capacities when the AN-aided scheme and RIS scheme are integrated according to the third exemplary embodiment of the present disclosure.

FIG. 18 is a graph comparing secrecy rates when the AN-aided scheme and RIS scheme are integrated according to the third exemplary embodiment of the present disclosure.

FIG. 19 is a graph comparing secrecy capacities when the PB-Alamouti scheme and

RIS scheme are integrated according to the third exemplary embodiment of the present disclosure, based on a predetermined range of factor values.

FIG. 20 is a graph comparing secrecy rates when the PB-Alamouti scheme and RIS scheme are integrated according to the third exemplary embodiment of the present disclosure, based on a predetermined range of factor values.

FIG. 21 is a graph comparing secrecy capacities of the AN-aided scheme using a relay according to the fourth exemplary embodiment of the present disclosure.

FIG. 22 is a graph comparing secrecy rates of the AN-aided scheme using a relay according to the fourth exemplary embodiment of the present disclosure.

FIG. 23 is a graph illustrating secrecy capacity performance of the aforementioned exemplary embodiments according to specific factor values.

FIG. 24 is a graph illustrating secrecy rate performance of the aforementioned exemplary embodiments according to specific factor values.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

A terrestrial network may be referred to as a wireless communication network and used interchangeably with a wireless communication system.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz.

The communication network to which the exemplary embodiments according to the present disclosure are applied is not limited to the contents described below, and the exemplary embodiments according to the present disclosure may be applied to various communication networks. Here, the communication network may be used in the same sense as the communication system.

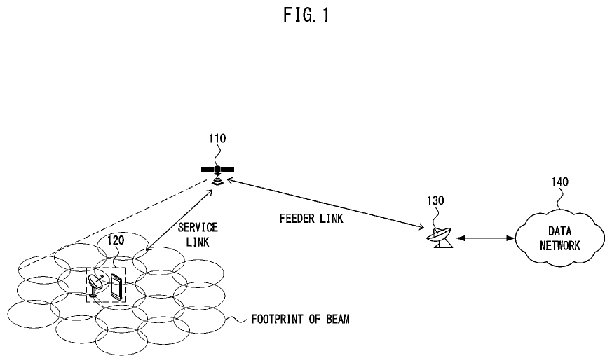

FIG. 1 is a conceptual diagram illustrating a non-terrestrial network to which a security enhancement method according to an exemplary embodiment of the present disclosure is applicable.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI).

The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

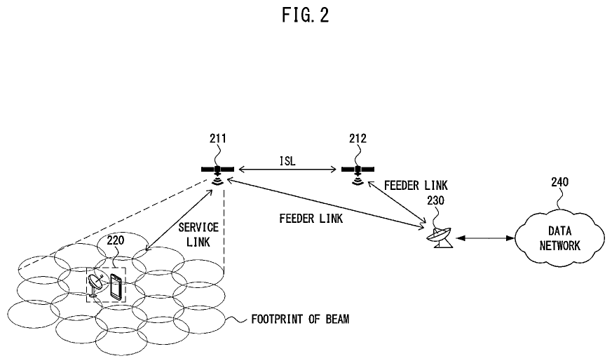

FIG. 2 is a conceptual diagram illustrating another non-terrestrial network to which a security enhancement method according to an exemplary embodiment of the present disclosure is applicable.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally.

The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

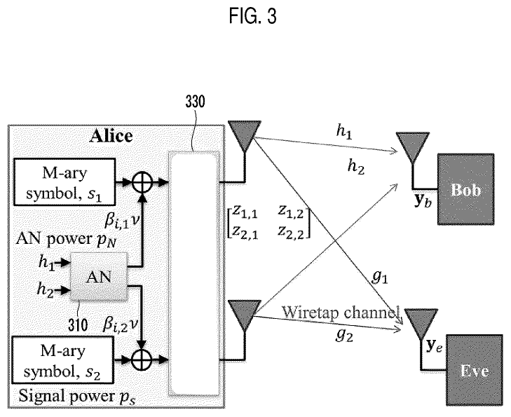

FIG. 3 is an exemplary diagram of a system model for describing an artificial noise (AN)-aided Alamouti code applicable to a security enhancement technique of the present disclosure.

Referring to FIG. 3, a system model for wireless communication comprises three main components: Alice, a legitimate transmitter; Bob, a legitimate receiver; and Eve, an eavesdropper. Alice is equipped with two antennas, while Bob and Eve each have one antenna. This results in a 2×1 system configuration.

It is assumed that Alice and Bob have access to channel state information (CSI). A channel vector between Alice and Bob may be represented as h=[h₁h₂]T. In addition, Eve has access to CSI at a level of a characteristic vector g=[g₁g₂]^{T} which characterizes a channel between Alice and Eve. Additionally, it is also assumed that Eve is located at a distance of several wavelengths from Bob, ensuring the independence between the two channel vectors.

Initially, an Alamouti code may encode two signals across two consecutive time slots, resulting in a 2×2 signal matrix. When two transmit signals to be encoded are denoted as s₁ and s₂, an Alamouti-encoded signal matrix may be represented as in Equation 1.

$$S = [ \begin{matrix}{s}_{1} & {s}_{2} \\ - {s}_{2}^{*} & {s}_{1}^{*}\end{matrix} ] \qquad [ Equation 1 ]$$

In Equation 1, s₁ and s₂ are signals at a time t, and −s₂* and s₁* are signals at a time t+T.

Then, for the artificial noise (AN)-added Alamouti code, the encoded signal matrix across two time slots may be represented as the Alamouti-encoded signal matrix with an AN matrix W added. The AN-assisted Alamouti-encoded signal matrix Z may be represented as in Equation 2.

$$Z = [ \begin{matrix}{z}_{1 , 1} & {z}_{1 , 2} \\ {z}_{2 , 1} & {z}_{2 , 2}\end{matrix} ] = S + W \qquad [ Equation 2 ]$$

In Equation 2, the AN matrix W may be expressed as in Equation 3.

$$W = [ \begin{matrix}{β}_{1 , 1} v & {β}_{1 , 2} v \\ - {( {β}_{2 , 1} v )}^{*} & {( {β}_{2 , 2} v )}^{*}\end{matrix} ] \qquad [ Equation 3 ]$$

Here, β_{i,k} represents a coefficient of a complex Gaussian random variable v for the i-th time slot and k-th transmit antenna. The complex Gaussian random variable is characterized by a mean of zero and unit variance.

As such, the transmitter Alice needs to be equipped with not only an Alamouti encoder 330 but also an AN generator 310, and it needs allocate power to the artificial noise in addition to a signal power. Consequently, a total transmit power of the transmitter may increase. Therefore, the coefficient β_{i,k} for the complex Gaussian random variable in the AN matrix for AN power needs to be designed as shown in Equation 4.

$$\begin{matrix}{β}_{1 , 1} {h}_{1} + {β}_{1 , 2} {h}_{2} = 0 \\ {β}_{2 , 1}^{*} {h}_{1} + {β}_{2 , 2}^{*} {h}_{2} = 0\end{matrix} \qquad [ Equation 4 ]$$

As shown in Equation 4, the AN may be canceled when received at Bob, and one of possible solution sets for β_{i,k} may be expressed as in Equation 5.

$${β}_{1 , 1} = - {h}_{2} , {β}_{1 , 2} = {h}_{1} {β}_{2 , 1} = {h}_{2}^{*} , {β}_{2 , 2} = {h}_{1}^{*} \qquad [ Equation 5 ]$$

In Equation 5, hᵢ represents an accumulated channel in the i-th channel.

According to the above description, a signal vector received by Bob may be expressed as in Equation 6.

$${y}_{b} = [ \begin{matrix}{( {y}_{b} )}_{1} \\ {( {y}_{b} )}_{2}\end{matrix} ] = [ \begin{matrix}{h}_{1} {s}_{1} + {h}_{2} {s}_{2} + {( {n}_{b} )}_{1} \\ {h}_{2} {s}_{1}^{*} - {h}_{1} {s}_{2}^{*} + {( {n}_{b} )}_{2}\end{matrix} ] \qquad [ Equation 6 ]$$

Here, (y_{b})ᵢ and (n_{b})ᵢ represent a signal and an additive white Gaussian noise (AWGN) received by Bob in the i-th time slot, respectively.

A detection process of Bob may be performed in the same manner as the conventional Alamouti scheme. That is, a signal vector detected at Bob does not include an interference vector generated by the artificial noise.

Meanwhile, a signal vector received by Eve may be expressed as in Equation 7.

$${y}_{e} = [ \begin{matrix}{( {y}_{e} )}_{1} \\ {( {y}_{e} )}_{2}\end{matrix} ] = [ \begin{matrix}{g}_{1} {s}_{1} + {g}_{2} {s}_{2} + {β}_{1 , 1} {g}_{1} + {β}_{1 , 2} {g}_{2} + {( {n}_{b} )}_{1} \\ {g}_{1} {s}_{1}^{*} - {g}_{1} {s}_{2}^{*} - {β}_{2 , 2} {g}_{1} + {β}_{2 , 2} {g}_{2} + {( {n}_{b} )}_{2}\end{matrix} ] \qquad [ Equation 7 ]$$

Here, (yₑ)ᵢ and (nₑ)ᵢ represent a signal and an AWGN received by Eve in the i-th time slot, respectively.

A signal vector detected by Eve's detection process may include both a signal for information transmission and an interference vector Wₑ incurred by the artificial noise.

The interference vector Wₑ incurred by the artificial noise is represented as in Equation 8.

$${w}_{e} = [ \begin{matrix}{g}_{1}^{*} v ( {g}_{1} {β}_{1 , 1} + {g}_{2} {β}_{1 , 2} ) - {g}_{2} v ( {g}_{1}^{*} {β}_{2 , 1} - {g}_{2} {β}_{2 , 2} ) \\ {g}_{2}^{*} v ( {g}_{1} {β}_{1 , 1} + {g}_{2} {β}_{1 , 2} ) + {g}_{1} v ( {g}_{1}^{*} {β}_{2 , 1} - {g}_{2} {β}_{2 , 2} )\end{matrix} ] \qquad [ Equation 8 ]$$

As described, Eve is subjected to interference from artificial noise (AN) in the form of the interference vector that remains independent of her signal-to-noise ratio (SNR). Therefore, if Eve attempts to extract information from the wireless communication channel, her eavesdropping operation becomes considerably complex.

Meanwhile, the aforementioned method protects information from unauthorized data access by introducing AN to interfere with the eavesdropper's signal. However, it has the drawback of requiring additional power for AN. That is, since AN is used independently of the transmit signal, the total transmit power of the transmitter is equal to a sum of the signal power and AN power. Thus, if equal power is allocated to both the signal and AN at the transmitter, a power loss of approximately 3 dB occurs at the transmitter.

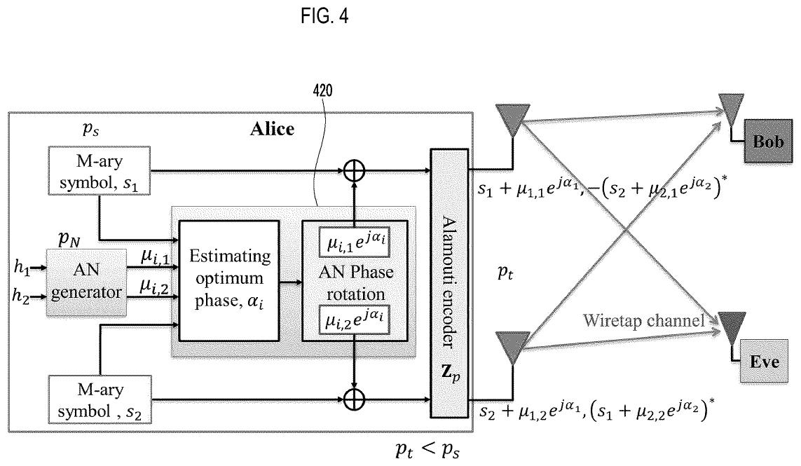

To address this issue, a power-balanced (PB) Alamouti method is known. The PB Alamouti method is a technique that mitigates the overall transmit power rather than requiring additional power allocation for physical layer security. In this technique, since both the transmit signal and AN are complex numbers, a signal-dependent complex AN is introduced to reduce the total transmit power. The operational concept of this technique will be described in more detail with reference to FIG. 4.

FIG. 4 is an exemplary diagram of a system model for describing an operational concept of a signal-dependent complex AN, which complements the AN-assisted Alamouti coding scheme in FIG. 3.

Referring to FIG. 4, a processor or communication controller of Alice initially generates artificial noise (AN) in a null space of a legitimate channel, then manipulates a phase of the AN to reduce an amplitude of the signal. That is, during each time slot, the complex-valued AN vector is rotated in the opposite direction of the signal to reduce the power of the transmit signal.

In other words, in the AN-assisted Alamouti coding scheme, an AN phase transformer 420 of Alice determines an optimal phase rotation for the AN by estimating an optimal phase and rotating the phase of AN, thereby minimizing the total transmit power.

When rotating the phase of AN, it is important to maintain the same orthogonality principle for the AN matrix within the encoding matrix or channel matrix to preserve a diversity gain from the Alamouti code. Therefore, Alice's transmission operation is controlled to apply the same phase rotation to ANs within the same time slot.

To achieve transmit power efficiency in the encoding matrix employing the PB-Alamouti code, an optimal phase rotation and AN power can be found using a specific objective function as in Equation 9.

$$arg {{min}_{{α}_{i} , {P}_{N}} ( {P}_{t} )}_{i} = {‖ {z}_{i , 1}^{′} ‖}^{2} + {‖ {z}_{i , 2}^{′} ‖}^{2} \qquad [ Equation 9 ]$$

Here, αᵢ represents a phase rotation in the i-th time slot, and (Pₜ)ᵢ denotes the total transmit power for the i-th time slot. Additionally, z_{i,1}′ and z_{i,2}′ are signals encoded at the first time t and second time t+T in the encoding matrix Z that employs the PB-Alamouti code.

A solution of Equation 9 indicates that the optimal AN power is half of the signal power, and the optimal phase rotation α_{i,opt} may be expressed as α_{i,opt}=π+ϕᵢ. Here, ϕᵢ=tan⁻¹ (χᵢ/ζᵢ), and χᵢ and ζᵢ are as in Equation 10.

$$\begin{matrix}{ζ}_{i} = {s}_{1}^{R} {μ}_{i , k = 1}^{R} + {s}_{1}^{I} {μ}_{i , k = 1}^{I} + {s}_{2}^{R} {μ}_{i , k \neq i}^{R} ++ {s}_{2}^{I} {μ}_{i , k \neq i}^{I} \\ {χ}_{i} = - {s}_{1}^{R} {μ}_{i , k = 1}^{I} + {s}_{1}^{I} {μ}_{i , k = 1}^{R} - {s}_{2}^{R} {μ}_{i , k \neq i}^{I} ++ {s}_{2}^{I} {μ}_{i , k \neq i}^{R}\end{matrix} \qquad [ Equation 10 ]$$

Here, α^{R} and α^{I} represent real and imaginary parts of a complex number α, respectively.

In summary, Alice estimates the AN matrix for each Alamouti-coded signal pair with optimal phase rotation and optimal AN power allocation, and transmits the PB-Alamouti code based on this estimation. Since the AN matrix is designed to be located in the null space of the legitimate channel, the signal detected at Bob remains identical to the conventional Alamouti signal, while the signal received by Eve encounters significant interference due to AN.

According to the theoretical analysis described above, the PB-Alamouti scheme achieves a power gain of 3 dB and 6 dB compared to the conventional Alamouti scheme without physical layer security (PLS) and the conventional AN-added Alamouti code, respectively.

Meanwhile, the physical layer security performance of Alamouti space-time block signals has limitations in environments such as time-selective fading channels. Therefore, the present disclosure provides a method for enhancing physical layer security performance using RIS. In particular, the physical layer security technique in the present disclosure is useful for strengthening physical layer security in low Earth orbit (LEO) satellite systems.

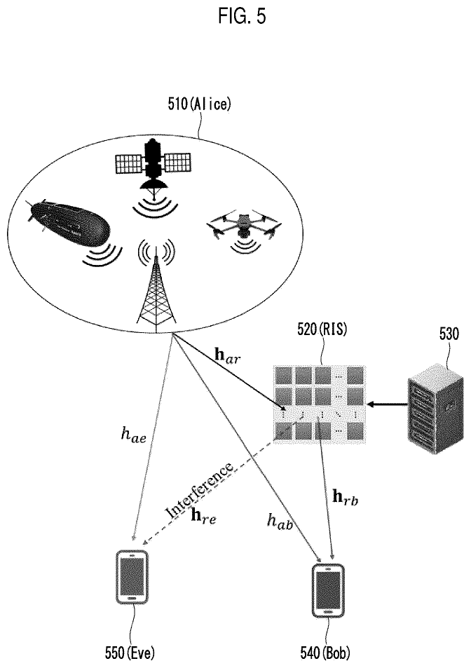

FIG. 5 is an exemplary diagram of a system model for an RIS-aided system applicable to a security enhancement technique of the present disclosure.

Referring to FIG. 5, a system model with a security enhancement technique of the present disclosure may be applied to all types of terrestrial networks (TN) and non-terrestrial networks (NTN), including satellite systems, high-altitude platform systems (HAPS), and drone platform systems.

The system model may comprise five main entities. The five main entities include a transmitter 510, intelligent reflecting surface (RIS) 520, controller 530, receiver 540, and eavesdropper 550.

The transmitter 510 may be a dynamic or static equipment equipped with means or devices for wireless communication, such as a satellite, drone, ship, submarine, vehicle, or base station, and may be referred to simply as Alice.

The RIS 520 enhances a signal strength for the receiver 540 while introducing interference to the eavesdropper 550.

The controller 530 manages phase adjustment of each RIS element in the RIS 520.

The receiver 540 is a legitimate receiver and may be referred to as user equipment (UE), terminal, etc. It may also be referred to as Bob.

The eavesdropper 550 is an unauthorized receiver or terminal and may be referred to as an eavesdropper device or Eve.

In a communication scenario of the present disclosure, it is assumed that Alice is tasked with transmitting information to Bob, while Eve attempts to eavesdrop on the information. The RIS 520 acts as an intelligent reflector with capability to manipulate phases of reflected signals. To protect the information, the RIS 520 may perform two operations or functions. Specifically, the RIS 520 may reflect signals toward Bob 540 for information delivery and reflect signals toward Eve 550 with the intent to cause interference.

To counter eavesdropping attempts of Eve 550, the controller 530, acting as a security enhancement device, may frequently adjust the phases of the RIS elements over a predefined period, such as a channel coherence time. The channel coherence time is a time period during which a channel impulse response (CIR) is considered constant. The phase adjustment of the RIS elements may involve dynamically rendering a channel experienced by Eve 550 within the predefined time while keeping a channel reflected to Bob 540 static.

In other words, the controller 530 may configure the RIS 520 to allow different combinations of phases of patch elements constituting the RIS for Bob and Eve by selecting fixed values for the RIS elements. Specifically, the phase adjustment of RIS elements may be implemented to set fixed values for the channel reflected from the RIS 520 to Bob 540 for a predefined time, such as the channel coherence time, while providing a channel environment for Eve 550 in which the phases are frequently adjusted.

Thus, the RIS 520, under the control of the controller 530, may randomly select one of multiple phase combinations of initially selected patch elements to set fixed values for a predefined time and perform phase adjustments for the RIS elements a predefined number of times.

Due to the phase adjustment of the RIS elements, Eve 550 experiences a time-varying channel over the predefined time, such as the channel coherence time. The dynamic nature of the reflected channel interferes with Eve 550, making it difficult for her to intercept the information transmitted from Alice 510.

The operational principle of the aforementioned RIS 520 will be described in more detail below.

The accumulated channel h_{b} from the transmitter Alice to the legitimate receiver Bob may be expressed as in Equation 11.

$${h}_{b} = {h}_{ab} + {h}_{rb} Θ {h}_{ar} \qquad [ Equation 11 ]$$

Here, h_{rb}∈ [symbol] ^{1×N}, hₐᵣ∈ [symbol] ^{N×1}, and Θ∈ [symbol] ^{N×N} are established. In addition, h_{ab} represents a direct channel between Alice and Bob, while h_{rb} and hₐᵣ are the respective channel vectors between the RIS and Bob and between Alice and the RIS. The variable N represents the number of RIS elements, and Θ represents a diagonal matrix composed of the phases of the RIS elements. The diagonal matrix Θ may be expressed as in Equation 12.

$$Θ = [ \begin{matrix}{e}^{j {θ}_{1}} & 0 & ⋯ & 0 \\ 0 & {e}^{j {θ}_{2}} & ⋯ & 0 \\ ⋮ & ⋮ & ⋱ & ⋮ \\ 0 & 0 & ⋯ & {e}^{j {θ}_{N}}\end{matrix} ] \qquad [ Equation 12 ]$$

Here, θᵢ denotes phase information of the i-th element of the RIS. The variable i is a natural number from 1 to N, and N is a natural number of 3 or more.

Additionally, the accumulated channel hₑ from Alice to the eavesdropper Eve may be expressed as in Equation 13.

$${h}_{e} = {h}_{ae} + {h}_{re} Θ {h}_{ar} \qquad [ Equation 13 ]$$

Here, hᵣₑ represents the channel vector between the RIS 520 and Eve, which may be represented as hᵣₑ∈ [symbol] ^{1×N}, and hₛₑ represents the direct channel between Alice and Eve.

Assuming that the controller 300 has access to channel information of Bob, the controller 300 may first predefine the accumulated channel h_{b} from Alice to Bob and then be configured to obtain a solution for Equation 11.

When decomposed into real-valued equations, Equation 11 becomes a set of two real-valued equations. For N>2, there may be multiple solutions to the diagonal matrix Θ included in Equation 11.

To estimate the diagonal matrix Θ for the accumulated channel h_{b} from Alice to Bob as previously given, the controller 300 may transform or re-express Equation 11 as shown in Equation 14.

$${h}_{b} = {h}_{ab} + {h}_{rb} diag ( {h}_{ar} ) v \qquad [ Equation 14 ]$$

Here, h_{rb}diag(hₐᵣ) denotes a diagonal matrix of hₐᵣ, and a matrix or set v of the phases of the RIS elements may be represented as v=[e^{jθ}^{₁},e^{jθ}^{₂}, . . . , e^{jθ}^{_{N}}]^{T}.

For simplification of Equation 14, a set t of time slots within a given time period may be defined as shown in Equation 15.

$$t = [ {t}_{1} , {t}_{2} , … , {t}_{N} ] = {h}_{rb} diag ( {h}_{ar} ) \qquad [ Equation 15 ]$$

In Equation 15, tₙ is the n-th element of a specific time slot set t in Alice's encoder. In this way, the time slot set t may be expressed as a product of the diagonal matrix of the accumulated channel from Alice to the RIS and the accumulated channel from the RIS to Bob.

Using Equation 15, Equation 14 may be expressed as shown in Equation 16.

$$tv - ( {h}_{b} - {h}_{ab} ) = 0 \qquad [ Equation 16 ]$$

For simplicity, a transpose matrix u of the phases may be denoted as u=[θ₁,θ₂, . . . ,θ_{N}]^{T}. In this case, the complex equation in Equation 16 may be decomposed by the controller 300 into two real-valued equations, as shown in Equation 17 and Equation 18.

$${f}_{1} ( u ) = {\sum }_{i = 1}^{N} [ cos ( {θ}_{i} ) - sin ( {θ}_{i} ) ] - ( - ) = 0 \qquad [ Equation 17 ]$$

$${f}_{2} ( u ) = {\sum }_{i = 1}^{N} [ sin ( {θ}_{i} ) + cos ( {θ}_{i} ) ] - ( {h}_{b}^{𝔍} - {h}_{ab}^{𝔍} ) = 0 \qquad [ Equation 18 ]$$

Here, a complex number a is defined as α= [symbol] +jα^{ℑ}, and f₁(u) and f₂(u) are functions of the transpose matrix u, representing the real and imaginary parts of Equation 16, respectively. For N>2, Equation 17 and Equation 18 form an underdetermined system of nonlinear equations. An underdetermined system is a set of equations with fewer equations than unknowns, allowing for infinite solutions due to the degrees of freedom in the unknowns, and is also referred to as an underdetermined system of equations.

To solve Equation 17 and Equation 18, the controller 300 may use the Newton-Raphson scheme, which can iteratively update the solution as shown in Equation 19.

$${u}_{k + 1} = {u}_{k} - {{J}_{{u}_{k}}^{T} ( {J}_{{u}_{k}} {J}_{{u}_{k}}^{T} )}^{- 1} F ( {u}_{k} ) \qquad [ Equation 19 ]$$

Here, uₖ denotes a solution u at the k-th iteration, and Jᵤ_{ₖ} denotes a Jacobian matrix of a multivariable vector function with respect to uₖ, which may be expressed as in Equation 20.

$${J}_{{u}_{k}} = \frac{\partial F ( {u}_{k} )}{\partial {u}_{k}} \qquad [ Equation 20 ]$$

Here, F(uₖ) denotes the multivariable vector function, which may be expressed as in Equation 21.

$$F ( {u}_{k} ) = [ \begin{matrix}{f}_{1} ( {u}_{k} ) \\ {f}_{2} ( {u}_{k} )\end{matrix} ] \qquad [ Equation 21 ]$$

Finally, a secrecy capacity Cₛ in terms of a difference between the achievable channel capacities of Bob and Eve may be estimated by the controller 300 as shown in Equation 22.

$${C}_{s} = {C}_{b} - {C}_{e} \qquad [ Equation 22 ]$$

Here, the channel capacity C_{b} of Bob may be estimated as in Equation 23.

$${C}_{b} = {log}_{2} ( 1 + \frac{{‖ {h}_{b} ‖}^{2}}{{σ}_{b}^{2}} ) \qquad [ Equation 23 ]$$

Here, σ_{b}² denotes a noise variance at Bob.

Then, since the accumulated channel hₑ from Alice to Eve depends on the diagonal matrix Θ, the channel capacity Cₑ of Eve may be estimated by the controller 300 as shown in

### Equation 24.

$${C}_{e} = {log}_{2} ( 1 + \frac{{‖ {E}_{Θ} [ {h}_{e} ] ‖}^{2}}{{‖ {h}_{e} - {E}_{Θ} [ {h}_{e} ] ‖}^{2} + {σ}_{e}^{2}} ) \qquad [ Equation 24 ]$$

Here, E_{Θ}[·] denotes an expectation operation with respect to the diagonal matrix Θ, and σₑ² denotes a noise variance at Eve.

As described above, determining the accumulated channel h_{b} from Alice to Bob is crucial. That is, determining the accumulated channel h_{b} may lead to three possible outcomes for the solutions of the diagonal matrix Θ, i.e. no root, a single root, and multiple roots.

In the present disclosure, the controller 300 may be configured to determine the accumulated channel h_{b} from Alice to Bob, with multiple roots existing to induce a random channel at Eve. The controller 300 may set Bob's channel capacity to be less than the maximum achievable capacity by using a weight α, as shown in Equation 25.

$${h}_{b} = α {h}_{b , opt} \qquad [ Equation 25 ]$$

Here, h_{b,opt} denotes Bob's maximum achievable capacity, corresponding to the optimum accumulated channel from Alice to Bob with the maximum available channel capacity. h_{b,opt} may be expressed as shown in Equation 26.

$${h}_{b , opt} = {h}_{ab} + {h}_{rb} {Θ}_{opt} {h}_{ar} \qquad [ Equation 26 ]$$

Here, the optimum diagonal matrix Θₒₚₜ may be expressed as shown in Equation 27.

$${Θ}_{opt} = {arg max}_{Θ} {‖ {h}_{ab} + {h}_{rb} Θ {h}_{ar} ‖}^{2} \qquad [ Equation 27 ]$$

According to the present disclosure, the controller 530, as a type of security enhancement device, may dynamically render the channel detected at the eavesdropper 550 while keeping the channel reflected toward the legitimate receiver 540 static for the same predefined time by adjusting the phases of the RIS elements of the RIS 520 in the wireless communication system where the eavesdropper 550 is present. In other words, the controller 530 may operate to prevent the eavesdropper 550 from successful eavesdropping by introducing a dynamic time-varying channel through frequent phase adjustments of the RIS elements during the predefined time, such as the channel coherence time.

Additionally, to prevent the operation of the eavesdropper 550, in the technique of frequently adjusting the phases of some RIS elements, the number of phase adjustments or phase adjustment intervals may be set differently depending on at least one of the following: a frequency used for communication between the legitimate transmitter 510 and the legitimate receiver 540, the movement speed of the transmitter 510 or receiver 540, the number of RIS elements per unit area, or the resolution of the RIS 520.

Furthermore, the coherence time is a statistical measure of a time duration over which the channel impulse response remains essentially invariant, quantifying the similarity of channel responses at different times. In other words, the coherence time is a time duration during which two received signals maintain a strong potential for amplitude correlation. If the coherence time is defined as a time duration with a temporal correlation function of at least 0.5, the channel coherence time T_{c} may be approximately expressed as shown in Equation 28.

$${T}_{c} \approx \frac{9}{16 π {f}_{m}} \qquad [ Equation 28 ]$$

Here, fₘ, denotes the maximum Doppler frequency.

Thus, the security enhancement device of the present disclosure frequently adjust the phases of the RIS elements in the RIS 520 to control a reciprocal bandwidth of a baseband signal at the receiver 540 due to the wireless signal reflected toward the receive 540 so that it remains below the channel coherence time, while also frequently changing the channel of the signals reflected toward the eavesdropper 550.

For example, if the coherence time is defined as a geometric mean of two approximate values as in Clarke's model, a 50% coherence time (hereinafter ‘half coherence time’) can be obtained at the maximum Doppler frequency. In this context, the security enhancement device may control the respective phases of the RIS elements so that the reciprocal bandwidth of the baseband signal at at least one legitimate receiver 540 remains below the half coherence time while also frequently changing at least one channel of the signals reflected to at least one eavesdropper 550.

Additionally, for example, the RIS controller 530, as a security enhancement device, may control the phases of the RIS elements so that, during an interval between reference signals or pilot signals for channel estimation, the channel is kept stable to allow accurate channel estimation at the legitimate terminal or receiver 540. In other words, the interval between reference signals or pilot signals may be set to be shorter than the coherence time of the channel, so that the channel remains unchanged for the duration of receiving the signal until the next reference or pilot signal is received, enabling adequate information detection. At the same time, the phases of the RIS elements can be controlled so that all channels other than the channel to the legitimate terminal or receiver 540 (i.e. the channels of the signals reflected to the eavesdropper's terminal or receiver 550) are changed at least once within the coherence time.

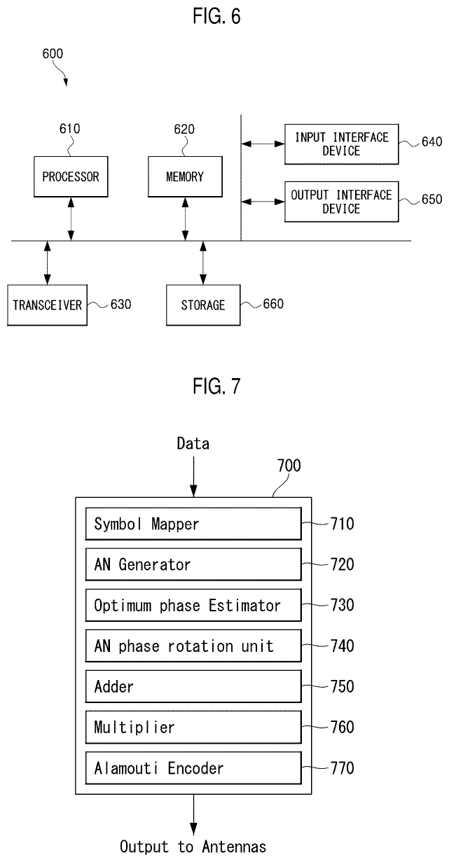

FIG. 6 is a block diagram illustrating configuration of a device applicable to a security enhancement device connected to the RIS in FIG. 5.

Referring to FIG. 6, a security enhancement device 600 may comprise at least one processor 610, a memory 620, and a transceiver 630 connected to the network for performing communications. Also, the security enhancement device 600 may further comprise an input interface device 640, an output interface device 650, a storage device 660, and the like. The respective components included in the security enhancement device 600 may communicate with each other as connected through a bus 270.

However, the respective components included in the security enhancement device 600 may be connected not to the common bus 670 but to the processor 610 through an individual interface or an individual bus. For example, the processor 610 may be connected to at least one of the memory 620, the transceiver 630, the input interface device 640, the output interface device 650, and the storage device 660 through dedicated interfaces

The processor 610 may execute a program stored in at least one of the memory 620 and the storage device 660. The processor 610 may refer to a central processing unit (CPU), a graphics processing unit (GPU), or a dedicated processor on which methods in accordance with embodiments of the present disclosure are performed. Each of the memory 620 and the storage device 660 may be constituted by at least one of a volatile storage medium and a non-volatile storage medium. For example, the memory 620 may comprise at least one of read-only memory (ROM) and random access memory (RAM).

FIG. 7 is a schematic block diagram of functional modules applicable to a security enhancement device of FIG. 6.

Referring to FIG. 7, a security enhancement device 700 may include a controller mounted on a transmitter (satellite). The security enhancement device 700 may primarily include a symbol mapper 710 for modulating input data and an Alamouti encoder 770 for supporting an Alamouti code. An output signal of the Alamouti encoder 770 may be combined with a signal modulated by the symbol mapper 710 and output through at least one antenna.

Additionally, when mounted on the transmitter, the security enhancement device 700 may include an AN generator 720 and a delay compensator (not shown) by default. In other words, the security enhancement device mounted on the transmitter may include the AN generator 720, an optimum phase estimator 730, an AN phase rotation unit 740, and an adder 750 to utilize AN and PB-aided Alamouti code.

Additionally, the security enhancement device 700, when mounted on the transmitter, may further include a multiplier 760 for assigning weights to the PB-assisted Alamouti code.

On the other hand, the security enhancement device 700 may be mounted on a control center that controls RIS operations. In this case, the security enhancement device 700 may include means, or a component that performs equivalent functions, for adjusting phases of first RIS elements, which are all or part of the RIS elements, at least once during a channel coherence time of a first signal transmitted between the transmitter and receiver. This allows for a channel related to the first signal to remain fixed during the coherence time while dynamically rendering a channel of another receiver or eavesdropper during the coherence time.

Furthermore, when the security enhancement device 700 is mounted on the control center, the security enhancement device 700 may include a selector for selecting the first RIS elements which are all or part of the RIS elements, a first estimator for estimating a one-dimensional matrix of the first RIS elements, a second estimator for estimating an array response vector and spatial frequencies necessary for reconstructing the array response vector using the estimated one-dimensional matrix, a third estimator for estimating a channel capacity of the first RIS elements using the array response vector and spatial frequencies, and a phase adjustment unit that changes the phases of the first RIS elements at least once over a duration of a given time slot based on the estimated channel capacity. The phase adjustment unit may be referred to as an interference generation unit and may be configured to dynamically render the channel of another receiver or eavesdropper without changing the channel between the transmitter and legitimate receiver for the predefined period.

Additionally, when mounted on the control center, the security enhancement device 700 may further include a multiplier 760 for assigning a weight to set the channel capacity to be less than the maximum channel capacity between the transmitter and receiver.

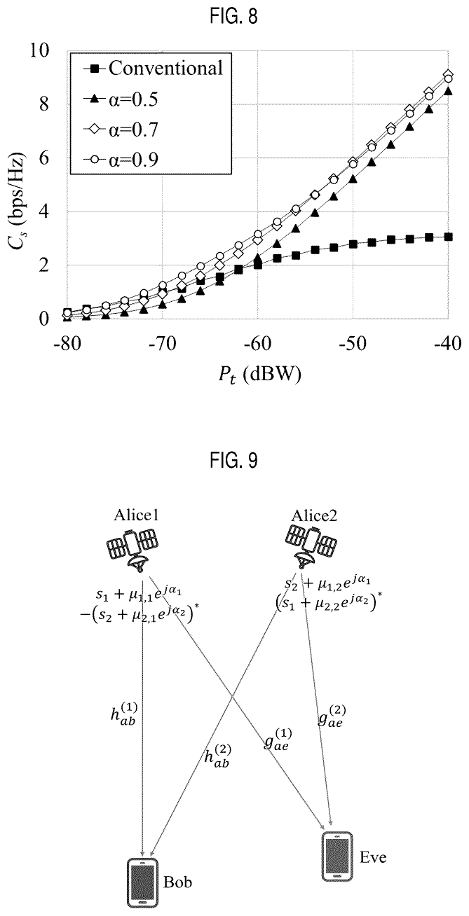

FIG. 8 is a graph illustrating a comparison of secrecy capacity performance between the system model of FIG. 5 and a comparative example.

Referring to FIG. 8, the conventional method in the comparative example uses the maximum channel capacity of Bob, the legitimate receiver, by simply fixing the phases of the RIS elements at optimal values. Here, the number of RIS elements is set to 8. The method of the present uses the channel capacities with weights a of 0.5, 0.7, and 0.9 assigned to the maximum channel capacity of Bob, the legitimate receiver.

The method of the present disclosure and the conventional method are within an approximate range in a low-power region. However, while the secrecy capacity Cₛ of the conventional method is nearly saturated in a high-power region, it can be observed that the secrecy capacity of the method of the present disclosure continues to increase as the transmit power Pₜ increases.

In the exemplary embodiment of the present disclosure, the secrecy capacity at the weight 0.7 is confirmed to be approximately 0.4 bps/Hz better than the secrecy capacity at the weight 0.5, as the channel capacity of Bob with the weight 0.7 is greater than that with the weight 0.5. Meanwhile, when Bob's channel capacity is continuously increased, the secrecy capacity slightly decreases in the high-power region, which may be due to excessive interference reduction at the eavesdropper, Eve, as the weight continues to increase.

For example, the secrecy capacity at the weight 0.9 is slightly better in some regions of the low-power and high-power regions compared to the secrecy capacity at the weight 0.7, but slightly worse in most other areas. Under these conditions, in terms of secrecy capacity, a weight in the vicinity of 0.7, i.e., a weight selected in the range of 0.5 to 0.9, may be considered the optimal range, with the weight 0.7 being considered the optimal weight in particular.

As described above, the security enhancement technique according to the present disclosure provides an RIS-supported physical layer security (PLS) scheme for satellite communication under conditions where a passive eavesdropper is present. Utilizing RIS in satellite communication allows for a substantial increase in channel capacity at the intended receiver, while simultaneously inducing interference at the eavesdropper without requiring knowledge of the eavesdropper's channel, making it easy to achieve the desired level of security.

In particular, the security enhancement technique according to the present disclosure can maintain a manageable state even if the number of eavesdroppers or antennas increases, thus serving as a practical security solution. Furthermore, the security enhancement technique according to the present disclosure can provide a stronger security solution by making the security dependent on interference at the eavesdropper, rather than the additive white Gaussian noise (AWGN) at the eavesdropper as in existing techniques.

Hereinafter, the security enhancement technique according to the present disclosure will be described in further detail through system models under various conditions. The security enhancement technique according to the present disclosure may utilize four approaches to enhance physical layer security (PLS) in low Earth orbit (LEO) satellite systems.

The first approach uses the Alamouti code with the aid of artificial noise (AN) and jointly employs two LEO satellites to ensure secure downlink transmission. The efficiency of the first approach is further improved when implementing a power-balanced Alamouti code.

The second approach introduces interference to potential eavesdroppers by utilizing a reconfigurable intelligent surface (RIS). Since the RIS manages the reflected channels, the PLS measures of the second approach can be achieved without requiring additional transmit power or receiver operations.

The third approach combines the first and second approaches, enhancing the secure transmission rate to nearly reach the maximum achievable rate compared to the individual approaches.

The fourth approach is based on a relay-based scheme that protects all transmission links from a satellite to a relay and from the satellite and relay to legitimate users.

Traditional cryptography (TC) faces issues related to power consumption and computational capacity in resource-constrained devices, such as IoT devices. Additionally, since TC encryption and decryption rely on mathematical algorithms, the encryption cannot theoretically be reversed without a decryption key. However, due to rapid advancements in computing power, encryption alone is no longer sufficient to prevent unauthorized individuals from accessing and exploiting confidential information.

To address the challenge of ensuring secure communication, multiple existing studies have proposed PLS schemes for multiple antenna systems, such as space-time block coding (STBC). One common PLS scheme for STBC is integration of artificial noise (AN). In such conventional methods, AN is strategically inserted into a null space of a legitimate channel, allowing it to be removed at a legitimate receiver while causing significant interference to unauthorized eavesdroppers.

However, using AN-assisted technique requires additional energy for the AN components, reducing power efficiency. Additionally, integrating AN that depends on channel characteristics may increase a peak-to-average power ratio, which places a burden on the power amplifier. These two drawbacks are particularly critical in satellite systems, where power resources are limited, and in high-power amplifiers that exhibit nonlinear characteristics. Reducing AN power may improve power efficiency by decreasing transmit power, but it also reduces interference to the eavesdropper, increasing the risk of information leakage.

For these reasons, the security enhancement technique of the present disclosure improves power efficiency by using an Alamouti scheme integrated with AN. Specifically, the PLS technique of the present disclosure introduces AN in a way that reduces total transmit power, eliminating the need for additional power consumption for security purposes. According to the security enhancement technique of the present disclosure, similar security performance to that of the conventional AN-assisted methods can be achieved in satellite systems with a power level of approximately 5 dB.

Meanwhile, reconfigurable intelligent surfaces (RIS), also known as smart surfaces, have gained significant attention in recent years as an effective means of enhancing not only security performance but also capacity. The RIS is configured as an array of passive elements capable of manipulating phases of electromagnetic signals. The phase manipulation of electromagnetic signals is used to achieve desired reflection and propagation characteristics of the signals. By dynamically controlling reflection patterns, the RIS shows potential to amplify signal strength, mitigate interference, and greatly improve communication performance within wireless networks.

In line with this trend, the present disclosure provides a new PLS method in the context of LEO satellite systems, specifically offering security enhancement methods based on artificial noise (AN), RIS support, relay support, or combinations of these methods.

According to the present disclosure, first, by introducing an application in LEO satellite systems that uses the Alamouti scheme with artificial noise, both security and power efficiency can be enhanced. Then, by using RIS to introduce a noisy channel for the eavesdropper, a new security enhancement method that disrupts eavesdropping attempts and ensures data security can be provided. As described above, the security enhancement method of the present disclosure applies a new concept of interference targeting the eavesdropper, allowing the legitimate channel to remain constant while dynamically altering the eavesdropper's channel.

In particular, to dynamically alter the eavesdropper's channel, the security enhancement method of the present disclosure can estimate the phases of RIS elements using an iterative technique known as the Newton-Raphson scheme. Additionally, the method of the present disclosure can strengthen transmission security in LEO satellite systems by using a relay, allowing all links to be protected by artificial noise.

In the following detailed description, the concepts of the power-balanced Alamouti code and RIS-aided security enhancement will be discussed more specifically with examples of system models.

In the following description, Eve is assumed to be a passive eavesdropper, and the legitimate transmitter Alice and receiver Bob are assumed not to have CSI for Eve. It is also assumed that the channel from Alice to Bob and the channel from Alice to Eve are independent. A summary of the four (No. 1 to No. 4) efficient PLS schemes for LEO satellite systems is shown in Table 1 below.

TABLE 1

| No. | MIMO configuration | PLS scheme |
|---|---|---|
| 1 | 2 × 1 (2 LEO, 1 UE) | AN-aided, power-balanced Alamouti |
| 2 | 2 × 1 (2 LEO, 1 UE) | RIS-aided |
| 3 | 2 × 1 (2 LEO, 1 UE) | AN + RIS-aided |
| 4 | 2 × 1 (2 LEO, 1 UE) | Relay-based |

FIG. 9 is an exemplary diagram of a system model for describing physical layer security (PLS) using a power-balanced (PB) Alamouti code in an LEO satellite system to which a security enhancement method of the present disclosure is applicable.

The security enhancement method of the present disclosure may enhance PLS using an AN-aided Alamouti code or a PB-Alamouti code.

Referring to FIG. 9, a system model includes two satellites, Alice1 and Alice2. Bob acts as an authorized receiver, and Eve acts as a potential passive eavesdropper. Each communication node is assumed to be equipped with a single antenna.

Alice1 and Alice2 may establish communication through a ground-based control sensor or an inter-satellite link. Additionally, Alice1 and Alice2 may be synchronized using a delay compensation technique.

To evaluate the security performance for PLS in the present exemplary embodiment, a secrecy capacity SC and a secrecy rate SR may be used. Here, the secrecy capacity SC may be defined as a capacity difference between Bob and Eve, as shown in Equation 29.

$${C}_{s} = max \{ 0 , {C}_{b} - {C}_{e} \} \qquad [ Equation 29 ]$$

Here, C_{b} and Cₑ represent the capacities of Bob and Eve, respectively, and may be expressed as shown in Equation 30 and Equation 31.

$${C}_{b} = {log}_{2} ( 1 + {SNR}_{b} ) \qquad [ Equation 30 ]$$

$${C}_{e} = {log}_{2} ( 1 + {SNR}_{e} ) \qquad [ Equation 31 ]$$

Here, SNR_{b} and SNRₑ represent an SNR of Bob and an SNR of Eve, respectively, and may be expressed as shown in Equation 32 and Equation 33.

$${SNR}_{b} = \frac{{‖ Sh ‖}^{2} / 2}{{σ}_{b}^{2}} \qquad [ Equation 32 ]$$

$${SNR}_{e} = \frac{{‖ Λg ‖}^{2} / 2}{{‖ Ω g ‖}^{2} / 2 + {σ}_{e}^{2}} \qquad [ Equation 33 ]$$

Here, Λ and Ω represent the signal matrix and AN matrix, respectively. Additionally, S and W represent the Alamouti-coded signal matrix and AN matrix, respectively. In the case of the AN-aided scheme, Λ=S, and Ω=W.

In the PB-Alamouti scheme, since the added AN and W contain signal-dependent information, they cannot be treated as pure noise. For this reason, W may be decomposed into signal-dependent information and a pure noise component, as shown in Equation 34.

$${W}^{′} = E [ {W}^{′} \vert S ] + {W}_{n}^{′} \qquad [ Equation 34 ]$$

Here, E[W′|S] and Wₙ′ represent the signal-dependent part and the pure noise part of W, respectively. In the present exemplary embodiment, E[W′|S] is a constant-valued matrix, which means that an eavesdropper could learn an identifiable pattern when a substantial volume of signals is received. Meanwhile, Wₙ′ is a pure random noise component with a mean of zero, representing the fluctuating component of W, so the eavesdropper cannot retrieve any identifiable pattern to collect information. Consequently, when using the PB-Alamouti code, A=S+E[W′|S] and Ω=Wₙ′. Additionally, σ_{b}² and σₑ² represent variances of the AWGN at Bob and Eve, respectively.

Additionally, the secure rate (SR), represented as Rₛ, may be formulated as shown in Equation 35, considering the difference in mutual information (MI) exchanged between Alice and Bob and between Alice and Eve. MI measures a mutual dependence between two variables and corresponds to a Kullback-Leibler divergence (KLD) between a joint probability distribution of the two variables and a product of their two marginal probability distributions.

$${R}_{s} = max \{ 0 , I ( {y}_{b} ; S ) - I ( {y}_{e} ; Λ ) \} \qquad [ Equation 35 ]$$

Here, I(y_{b};S) represents the MI of Bob, and I(yₑ;Λ) represents the MI of Eve.

Meanwhile, if S_{A} is a set of Alamouti-coded matrices S obtained through M-ary modulation, the set of matrices S may be expressed as S_{A}={S₁, . . . , S₍ₗ₎, . . . , S_{(M}_{²}₎}. Here, M denotes a modulation order, and S₍ₗ₎ denotes the 1-th element in the set S_{A}. Then, the MI between Alice and Bob may be estimated as shown in Equation 36.

$$I ( {y}_{b} ; S ) = {log}_{2} M - \frac{1}{2 {M}^{2}} {\sum }_{l}^{{M}^{2}} {E}_{h , {n}_{b}} ( {log}_{2} {\sum }_{q}^{{M}^{2}} {( {Ψ}_{b} )}_{l , q} ) \qquad [ Equation 36 ]$$

Here, E_{h,n}_{_{b}}[·] denotes an expected operation over the variables h and np. Additionally, (Ψ_{b})_{i,q} denotes a momentum operator of the 1-th and q-th elements and may be expressed as shown in Equation 37.

$${( {Ψ}_{b} )}_{l , q} = exp ( - ( {\vert {d}_{b} + {n}_{b} \vert}^{2} - {\vert {n}_{b} \vert}^{2} ) / {σ}_{b}^{2} ) \qquad [ Equation 37 ]$$

Here, d_{b}=(S₍ₗ₎−S_{(q)})h. The momentum operator may also be referred to as a wave function or a total energy operator.

Similarly, in the case of the AN-aided Alamouti scheme, I(yₑ;Λ) may be expressed as shown in Equation 38.

$$I ( {y}_{e} ; Λ ) = {log}_{2} M - \frac{1}{2 {M}^{2}} {\sum }_{l}^{{M}^{2}} {E}_{g , {n}_{e}^{′}} ( {log}_{2} {\sum }_{q}^{{M}^{2}} {( {Ψ}_{b} )}_{l , q} ) \qquad [ Equation 38 ]$$

Here, nₑ′=Ωg+nₑ and dₑ=(Λ₍ₗ₎−Δ_{(q)})g. In addition, Λ₍ₗ₎=S₍ₗ₎, and in both the AN-aided scheme and the PB-Alamouti scheme, Λ₍ₗ₎=S₍ₗ₎+E[W′|S₍ₗ₎]. If σ′ₑ² is a variance of n′ₑ, it may be expressed as σ′ₑ²=E[n′ₑ^{H}n′ₑ].

As described above, the security enhancement method of the present disclosure can enhance PLS in LEO satellite systems by using either the AN-aided or PB-Alamouti scheme. In particular, PLS can be enhanced by considering the difference between the MI exchanged between Alice and Bob and the MI exchanged between Alice and Eve.

The following is the second proposal for PLS in LEO satellite systems, describing a method that utilizes RIS to induce interference to the eavesdropper.

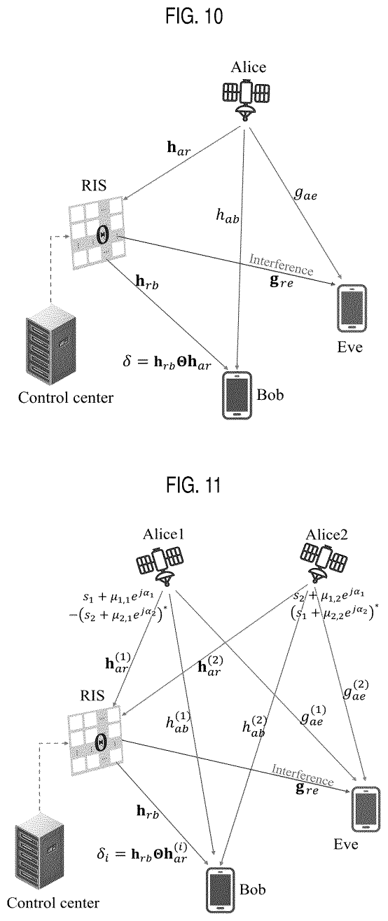

FIG. 10 is an exemplary diagram of a system model for describing RIS-aided interference-invoking PLS in a LEO satellite system to which a security enhancement method of the present disclosure is applicable.

Referring to FIG. 10, a LEO satellite system may include a transmitter (Alice) with a single antenna, a legitimate receiver (Bob), and an eavesdropper (Eve), each of which may be referred to as a communication node. Each communication node is equipped with a single antenna. The LEO satellite system also includes an RIS with N elements. The RIS may be controlled by a control center. The control center may include a controller that controls the operation of the RIS to enhance a signal strength for Bob while disrupting a signal for Eve.

To achieve this, the security enhancement method of the present exemplary embodiment introduces random noise to Eve while maintaining a constant amplitude for Bob during a coherence time assuming that all channels remain constant. Thus, the RIS may frequently randomize the phases of some of the RIS elements to interfere with Eve without causing interference to Bob. Specifically, some RIS elements need to be designed under the constraint of Bob's channel, i.e. under the constraint of the infinite solutions of the RIS elements.

A method for ensuring an infinite number of solutions for the RIS elements to maintain Bob's channel constant while inducing a noisy channel at Eve will be described in detail.

In FIG. 10, h_{ab} represents the direct channel between Alice and Bob, hₐᵣ represents the channel between Alice and the RIS, h_{rb} represents the channel between the RIS and Bob, gₐₑ represents the direct channel between Alice and Eve, and gᵣₑ represents the channel between the RIS and Eve.

The signal received at Bob may be expressed as shown in Equation 39.

$${y}_{b} = ( {h}_{rb} Θ {h}_{ar} + {h}_{ab} ) S + {n}_{b} \qquad [ Equation 39 ]$$

Here, S is the transmit signal, and ng is the AWGN at Bob. Accordingly, the signal received by Eve may be expressed as shown in Equation 40.

$${y}_{e} = ( {g}_{re} Θ {h}_{ar} + {h}_{ae} ) S + {n}_{b} \qquad [ Equation 40 ]$$

Here, nₑ represents the AWGN at Eve.

In the present exemplary embodiment, since Eve is assumed to be secretly eavesdropping on the signal transmitted by Alice, the control center cannot control the signal strength at Eve. Instead, the focus is on optimizing the phases of the RIS elements to maximize the signal strength received by Bob.

To apply interference by the RIS, the phases of the RIS elements need to be randomized to generate a random channel from the RIS to the eavesdropper. In this manner, the RIS may function as a jamming device against Eve. For this purpose, Bob's channel is maintained constant during the coherence time, while Eve's channel remains random.

Meanwhile, considering the solution to the optimization problem for Equation 11, the optimal accumulated channel from Alice to Bob may be simply expressed as shown in Equation 41.

$${h}_{rb} {Θ}_{opt} {h}_{ar} + {h}_{ab} = {δ}_{max} + {h}_{ab} \qquad [ Equation 41 ]$$

Here, the optimized phases of the RIS elements, Θₒₚₜ, are expressed as Θₒₚₜ=diag(vₒₚₜ), and δₘₐₓ may be expressed as δₘₐₓ=h_{rb}Θₒₚₜhₐᵣ. This may be interpreted as the optimal reflected channel coefficient achievable through the solution to the optimization problem.

Using δₘₐₓ described above, Bob can achieve the maximum accumulated channel capacity. The optimal phases Θₒₚₜ of the RIS elements to achieve δₘₐₓ are a single solution, so Θₒₚₜ remains static during the coherence time and, therefore, Θₒₚₜ cannot be used to introduce random interference to Eve.

To address this issue, the control center uses a constant reflected channel coefficient δ for Bob. This constant reflected channel coefficient becomes a random channel gain for Eve during the coherence time. That is, the constant reflected channel coefficient may be expressed as shown in Equation 42.

$$δ = {h}_{rb} Θ {h}_{ar} \qquad [ Equation 42 ]$$

Here, if |δ|>|δₘₐₓ|, there is no solution. However, if |δ|<|δₘₐₓ|, an infinite number of solutions exist. Therefore, the control center implementing the security enhancement method of the present exemplary embodiment may configure the condition |δ|<|δₘₐₓ| and use multiple solutions of the phases of the RIS elements to induce dynamic interference at Eve. Under this condition, the constant reflected channel coefficient remains constant during the coherence time, allowing Bob to detect the signal simply without any knowledge of the phases of the RIS elements.

Additionally, in the present exemplary embodiment, multiple solutions for the phases of the RIS elements may be found using the Newton-Raphson scheme. Specifically, various phase values of the RIS elements may be obtained through each initial condition of the Newton-Raphson scheme.

The method of finding multiple solutions of the phases of the RIS elements from Equation 42 to generate harmful interference at Eve using the aforementioned Newton-Raphson scheme may be essentially the same as described in Equations 11 to 21. Ultimately, the phase values of the RIS elements may be directly estimated from the configurable phases of the RIS elements, expressed as Θ=diag(e^{ju}). The various solutions for these phases vary according to each initial guess u₀. Therefore, by imposing u₀ varying over time, the control center may find as many solutions as possible for the phases of the RIS elements.

In this manner, the control center may apply random multiple solutions to the constant reflected channel coefficient expressed in Equation 42 and frequently adjust the phases of the RIS elements, causing Eve to experience a noisy channel. In other words, since the reflected channel gᵣₑΘhₐᵣ at Eve is undetermined, it will cause severe interference for Eve. Thus, high security protection can be achieved in LEO satellite systems through RIS-aided interference invoking.

The following describes the third approach for PLS in LEO satellite systems: an integrated approach of PB-Alamouti or AN-aided PLS and RIS-aided PLS.

FIG. 11 is an exemplary diagram of a system model for describing PLS using a PB-Alamouti code and RIS based on the integrated manner in a LEO satellite system to which a security enhancement method of the present disclosure is applicable.

Referring to FIG. 11, a LEO satellite system may employ an AN-aided PLS scheme, such as a PB-Alamouti scheme combined with RIS. In the present exemplary embodiment, security protection is provided by two sources: the AN from the satellite and the interference from the RIS.

To formalize the AN from the satellite and the interference from the RIS, the channel variables are redefined as h_{ab}⁽¹⁾ and h_{ab}⁽²⁾, representing the direct channels from Alice1 to Bob and from Alice2 to Bob, respectively. Similarly, the channel variables gₐₑ⁽¹⁾ and gₐₑ⁽²⁾ represent the direct channels from Alice1 to Eve and from Alice2 to Eve, respectively. The channel vectors from Alice1 to the RIS and from Alice2 to the RIS are denoted by hₐᵣ⁽¹⁾ and hₐᵣ⁽²⁾, respectively. Additionally, h_{rb} and gᵣₑ represent the channel vectors from the RIS to Bob and from the RIS to Eve, respectively. Finally, the i-th constant reflected channel coefficient of the RIS elements for Bob may be expressed as δᵢ=h_{rb}Θhₐᵣ⁽ⁱ⁾.

The first signal sₜ₁ transmitted from Alice1 may be expressed as shown in Equation 43, and the second signal sₜ₂ transmitted from Alice2 may be expressed as shown in Equation 44. The first and second signals each include the transmit signal and artificial noise.

$${s}_{t 1} = [ \begin{matrix}{s}_{1} + {μ}_{1 , 1} {e}^{{ja}_{1}} \\ ‐ {( {s}_{2} + {μ}_{2 , 1} {e}^{{ja}_{2}} )}^{*}\end{matrix} ] \qquad [ Equation 43 ]$$

$${s}_{t 2} = [ \begin{matrix}{s}_{2} + {μ}_{1 , 2} {e}^{{ja}_{1}} \\ {( {s}_{1} + {μ}_{2 , 2} {e}^{{ja}_{2}} )}^{*}\end{matrix} ] \qquad [ Equation 44 ]$$

Specifically, the signal vector received at Bob may be expressed as shown in Equation 45.

$${y}_{b} = S {h}^{⋁} + {n}_{b} = [ \begin{matrix}{{h}_{1}}^{⋁} {s}_{1} + {{h}_{2}}^{⋁} {s}_{2} + {( {n}_{b} )}_{1} \\ {{h}_{2}}^{⋁} {s}_{1}^{*} - {{h}_{1}}^{⋁} {s}_{2}^{*} + {( {n}_{b} )}_{2}\end{matrix} ] \qquad [ Equation 45 ]$$

Here, ȟₗ may be expressed as shown in Equation 46.

$${h}_{i} = {h}_{rb} Θ {h}_{ar}^{( i )} + {h}_{ab}^{( i )} = {δ}^{( i )} + {h}_{ab}^{( i )} \qquad [ Equation 46 ]$$

When |δ|<|δₘₐₓ|, δₘₐₓ⁽ⁱ⁾=h_{rb}Θₒₚₜhₐᵣ⁽ⁱ⁾, and ȟ=[ [symbol] ]^{T}.

In addition, the signal vector received at Eve may be expressed as in Equation 47.

$${y}_{e} = Λ {g}^{‵} + {{n}^{⋁}}_{e} \qquad [ Equation 47 ]$$

Here, è may be expressed as \grave{g}=g_{Θ}+[gₐₑ⁽¹⁾gₐₑ⁽²⁾]^{T}, g_{Θ} represents Eve's knowledge of the reflected channel vector, and [symbol] , which has variable values, represents Eve's accumulated interference-plus-noise vector. [symbol] may be expressed as shown in Equation 48.

$${{n}^{⋁}}_{e} = {\dot{n}}_{e} + {\ddot{n}}_{e} + {n}_{e} \qquad [ Equation 48 ]$$

Here, \dot{n}ₑ is the noise vector received due to artificial noise (AN), \ddot{n}ₑ is the interference vector received from the RIS, and nₑ is the AWGN vector.

The noise vector may be expressed as shown in Equation 49, and the interference vector may be expressed as shown in Equation 50.

$${\dot{n}}_{e} = Ω {g}^{⋁} = Ω [ \begin{matrix}{{g}^{⋁}}_{1} \\ {{g}^{⋁}}_{2}\end{matrix} ] \qquad [ Equation 49 ]$$

Here, [symbol] may be expressed as [symbol] =gᵣₑΘhₐᵣ⁽ⁱ⁾+gₐₑ⁽ⁱ⁾.

$${\ddot{n}}_{e} = Λ \ddot{g} = Λ ( {g}_{Θ} - [ \begin{matrix}{g}_{re} Θ {h}_{ar}^{( 1 )} \\ {g}_{re} Θ {h}_{ar}^{( 2 )}\end{matrix} ] ) \qquad [ Equation 50 ]$$

The secrecy capacity of the integrated system in the present exemplary embodiment may be estimated by inserting the SNR values for Bob and Eve into Equation 51 and Equation 52, respectively.

$${SNR}_{b} = \frac{{‖ S \check{h} ‖}^{2} / 2}{{σ}_{b}^{2}} \qquad [ Equation 51 ]$$

$${SNR}_{e} = \frac{{‖ Λ g ‖}^{2} / 2}{‖ Ω {g}^{⋁} + Λ \ddot{g} {\vert \vert}^{2} / 2 + {σ}_{e}^{2}} \qquad [ Equation 52 ]$$

Similarly, the secrecy transmission rate for each of Bob and Eve may be estimated using the mutual information (MI) for each of them. For example, the secrecy transmission rates may be estimated by inserting the MI values estimated for Bob and Eve into Equation 35.

According to the exemplary embodiment, the eavesdropper's operations within a LEO satellite system may be conveniently and effectively disrupted through the satellite's AN and the interference from the RIS.

The following describes AN-aided PLS in a satellite system that uses a ground relay as a component.

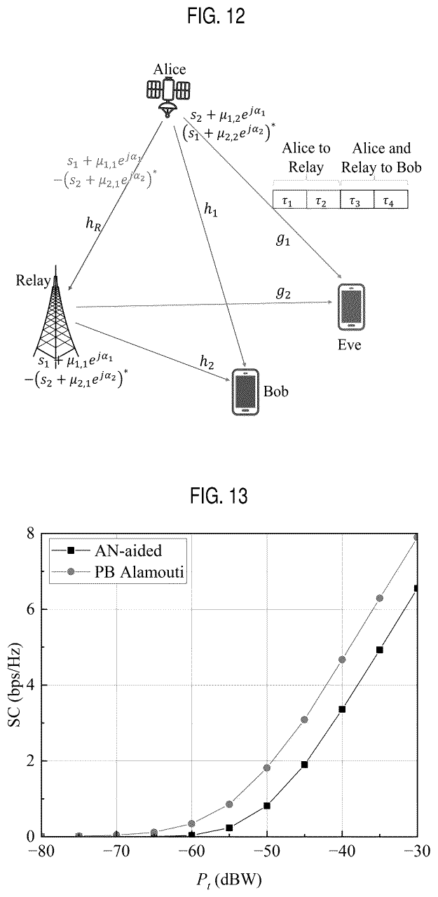

FIG. 12 is an exemplary diagram of a system model for describing a relay-based PB-Alamouti code for a LEO satellite system to which a security enhancement method of the present disclosure is applicable.

Referring to FIG. 12, a satellite communication system may include a transmitter Alice, a receiver Bob, an eavesdropper Eve, and a relay.

A channel gain h₁ for the direct path between Alice and Bob is assumed to be much weaker than channel gains h_{R} and h₂ for the path connecting Alice to the relay and the relay to Bob. Therefore, the present exemplary embodiment assumes that the relay plays an important role in improving the signal quality received by Bob.

That is, the relay occupies a crucial position in maintaining a secure communication link between Alice and Bob. To operate the satellite system within a reliable PLS environment, a controller in the present exemplary embodiment uses a time division scheme. The controller may be primarily mounted on a satellite which is Alice. Additionally, the controller is not limited to being mounted on Alice, and it may also be mounted on another satellite, relay, control center, or another communication node within the satellite system that is connected to Alice or synchronized to transmit and receive control communications with Alice.

In the present exemplary embodiment, the controller may divide time into four distinct time slots, labeled τ₁ through τ₄, to apply the time division scheme. In this case, during time slots τ₁ and τ₂, Alice transmits two signals, S₁+μ_{1,1}e^{jα}^{₁} and −(S₂+μ_{2,1}e^{jα}^{₂})*, to the relay. Additionally, Alice may designate time slots τ₃ and τ₄ to transmit PB-Alamouti-coded signals from both Alice and the relay to Bob.

During the time slots τ₁ and τ₂, even if Eve attempts to intercept the signal that Alice transmits to the relay, Eve may still experience the effects of AN, which ultimately ensures the security of the satellite network link in each time slot.

In this configuration, Alice needs to access channel information related to the link between herself and Bob, as well as the link between the relay and Bob. This channel information is essential for designing the AN. For this purpose, the AN for the PB-Alamouti code may be designed as a function of h₁ and h₂ (see Equations 1 to 8, particularly Equation 4).

The signal y_{R} received at the relay during the time slots τ₁ and τ₂ may be expressed as shown in Equation 53.

$${y}_{R} = [ \begin{matrix}{h}_{R} ( {s}_{1} + {μ}_{1 , 2} {e}^{j {α}_{1}} ) + {( {n}_{R} )}_{1} \\ {h}_{R} ( {s}_{2} + {μ}_{2 , 2} {e}^{j {α}_{2}} ) + {( {n}_{R} )}_{2}\end{matrix} ] \qquad [ Equation 53 ]$$

Here, (N_{R})₁ and (N_{R})₂ are the AWGN at the relay during the time slots τ₁ and τ₂, respectively.

The relay does not directly detect the original signal. Instead, it can identify the signal transmitted by Alice by effectively removing the channel coefficient from the received signal. Consequently, the detected signal at the relay may be expressed as shown in Equation 54.

$${s}_{R} = \frac{{y}_{R}}{{h}_{R}} = [ \begin{matrix}{s}_{1} + {μ}_{1 , 2} {e}^{j {α}_{1}} + {( {\tilde{n}}_{R} )}_{1} \\ {( {s}_{2} + {μ}_{2 , 2} {e}^{j {α}_{2}} )}^{*} + {( {\tilde{n}}_{R} )}_{2}\end{matrix} ] \qquad [ Equation 54 ]$$

Here, (ñ_{R})ᵢ may be expressed as

$${( {\tilde{n}}_{R} )}_{i} = \frac{{( {n}_{R} )}_{i}}{{h}_{R}} .$$

In the time slots τ₃ and τ₄, the signal matrix may be expressed as shown in Equation 55.

$${Z}_{R} = S + Ω + [ \begin{matrix}0 & {( {\tilde{n}}_{R} )}_{1} \\ 0 & {( {\tilde{n}}_{R} )}_{2}\end{matrix} ] \qquad [ Equation 55 ]$$

Then, the signal vector \grave{y}_{b} received at Bob may be expressed as shown in Equation 56.

$${{y}^{‵}}_{b} = [ \begin{matrix}{( {{y}^{‵}}_{b} )}_{1} \\ {( {{y}^{‵}}_{b} )}_{2}\end{matrix} ] = {Z}_{R} h = [ \begin{matrix}{h}_{1} {s}_{1} + {h}_{2} {s}_{2} + {{h}_{2} ( {\tilde{n}}_{R} )}_{1} + {( {n}_{b} )}_{1} \\ {h}_{1} {s}_{1} + {h}_{2} {s}_{2} + {{h}_{2} ( {\tilde{n}}_{R} )}_{1} + {( {n}_{b} )}_{1}\end{matrix} ] \qquad [ Equation 56 ]$$

Here, when h=[h₁h₂]^{T}, h₁ and h₂ may represent the channel gains of the relay for Alice and Bob, respectively.

Similarly, the signal vector received at Eve may be expressed as shown in Equation 57.

$${{y}^{‵}}_{e} = [ \begin{matrix}{( {{y}^{‵}}_{e} )}_{1} \\ {( {{y}^{‵}}_{e} )}_{2}\end{matrix} ] = {Z}_{R} g = [ \begin{matrix}{g}_{1} ( {s}_{1} - {μ}_{1 , 1} {e}^{j {α}_{1}} ) + {g}_{2} ( {s}_{2} - {μ}_{1 , 2} {e}^{j {α}_{1}} ) \\ {{g}_{2} ( {s}_{1} + {μ}_{2 , 2} {e}^{j {α}_{2}} )}^{*} - {{g}_{1} ( {s}_{2} - {μ}_{2 , 1} {e}^{j {α}_{2}} )}^{*}\end{matrix} ] + [ \begin{matrix}{{g}_{2} ( {\tilde{n}}_{R} )}_{1} + {( {n}_{e} )}_{1} \\ {{g}_{2} ( {\tilde{n}}_{R} )}_{2} + {( {n}_{e} )}_{2}\end{matrix} ] \qquad [ Equation 57 ]$$

Here, g may be expressed as g=[g₁g₂]^{T}. g₁ and g₂ may represent the channel gains from Alice and the relay to Eve, respectively.

According to the present exemplary embodiment, due to the utilization of the relay, the secrecy capacity and secrecy transmission rate are influenced not only by the receiver noise but also by ñ_{R}. That is, the secrecy capacity and secrecy transmission rate with respect to Eve may be further impacted by the additional noise inserted by the relay. Therefore, effective AN-aided PLS can be ensured in the LEO satellite system by utilizing the relay.

To evaluate the security enhancement performance of the aforementioned exemplary embodiments, a system configuration as shown in Table 2 was used, with simulation results related to secrecy, particularly secrecy capacity (SC) and secrecy transmission rate (SR), shown in FIGS. 13 to 24.

The evaluation system operates in a 12 GHz frequency band and uses a satellite positioned at an altitude of 1000 km. The transmit antenna gain is fixed at 30 dBi, and the receive antenna gain and noise spectral density for all receiving components are uniformly set to 5 dBi and −200 dBW/Hz, respectively. Additionally, a 5 dB loss, such as rain fading, is applied to all links of the satellite.

[Equation 2]

| PLS scheme | Channel model | FIGS |
|---|---|---|
| AN-aided | From Sat.: Rician, K∈U(5, 15)dB | 13 and 14 |
| PB-Alamouti | — | — |
| RIS-aided | From Sat.: Rician, K∈u(5, 15)dB | 15 and 16 |
| RIS + AN-aided | RIS to user: Rayleigh | 17 and 18 |
| RIS-aided + | — | 19 and 20 |
| PB-Alamouti | | |
| Relay-based | Sat. to relay: Gaussian | 21 and 22 |

Table 2 summarizes the simulation configuration for all the PLS schemes described in the present disclosure, along with the corresponding drawings showing security performance. The channel from the satellite (sat.) to all ground components is assumed to be a Rician fading channel with a Rician factor K that has a uniform probability density function (PDF), U(5,15) dB, for the satellite system. Here, U(a,b) represents a uniform PDF within a range from a to b. For simulations of the relay-based PLS scheme, the channel between the satellite and relay is assumed to be Gaussian, while the channel between the satellite and user is assumed to be a Rician fading channel with a Rician factor K. To ensure the channel between the satellite and relay is better than the channel from the satellite to the user, the satellite-relay link is assumed to be a Rician fading channel with U(−3,3) dB. Meanwhile, all channels between the ground components are considered Rayleigh fading channels.

Additionally, the modulation schemes used in the simulations include both quadrature phase shift keying (QPSK) and 16-quadrature amplitude modulation (16QAM). In all simulations using the AN-based method, the AN power is set equal to the transmit signal power. It is also assumed that the RIS in all systems utilizing RIS technology is mounted on a building or tower. A distance from the RIS to Bob and Eve is fixed at 500 meters, and the number of RIS elements is set to 200.

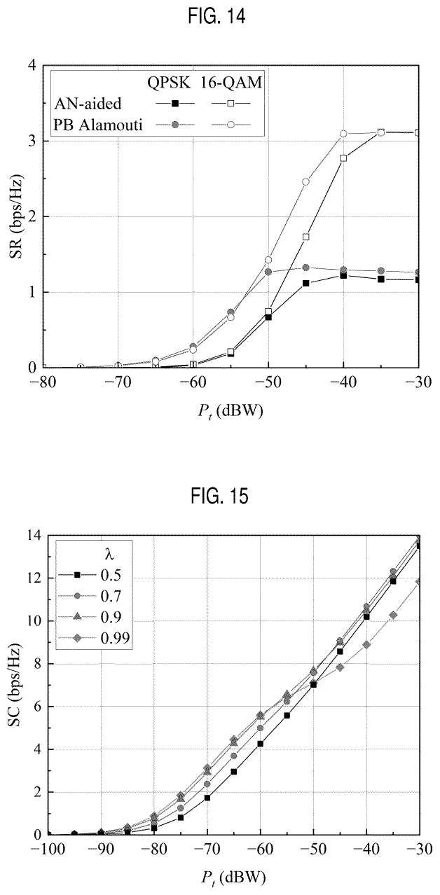

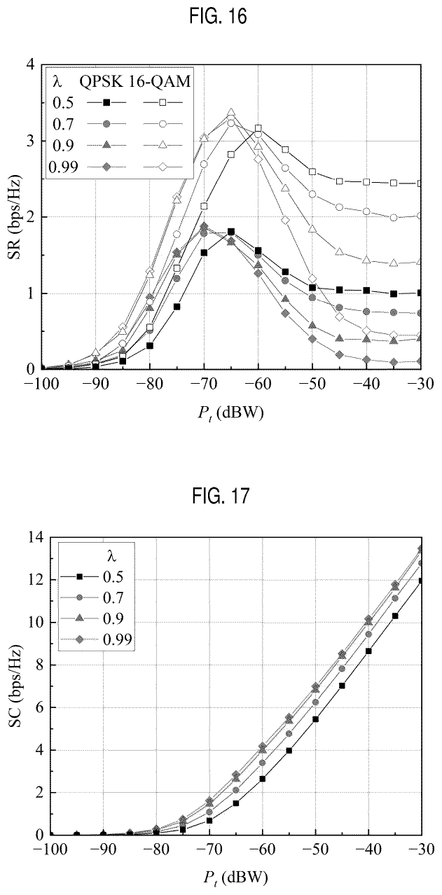

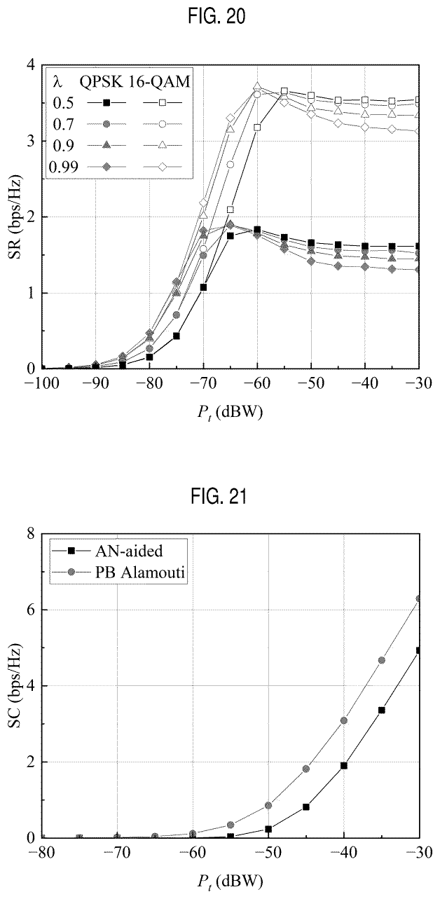

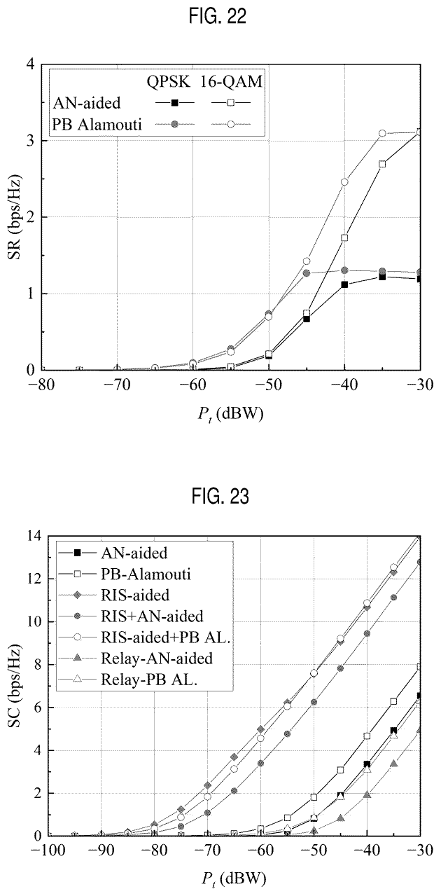

In the system model for the first PLS approach, which includes the joint use of two satellites, two PLS schemes are applied: the AN-aided scheme and the PB-Alamouti scheme. FIGS. 13 and 14 illustrate security performance of the first PLS approach. FIGS. 15 and 16 illustrate evaluation results for the second PLS approach, the RIS-aided PLS scheme. For the third PLS approach, two options—integrating RIS with either the AN-aided or PB-Alamouti scheme—may be applied in the system model. FIGS. 17 and 20 illustrate evaluation results for the third PLS approach. Finally, FIGS. 21 and 22 illustrate evaluation results of the fourth PLS approach, which employs relay-based technology compatible with the AN-aided and PB-Alamouti scheme.

FIG. 13 is a graph comparing a secrecy capacity (SC) between the AN-aided scheme and the PB-Alamouti code scheme in the first exemplary embodiment of the present disclosure. FIG. 14 is a graph comparing a secrecy rate (SR) between the AN-aided scheme and the PB-Alamouti code scheme in the first exemplary embodiment of the present disclosure.

FIGS. 13 and 14 respectively illustrate the secrecy capacity (SC) and secrecy rate (SR) performance of the first PLS approach. The SC and SR performance evaluation results for the first PLS approach demonstrate the feasibility of applying both the AN-aided and PB-Alamouti schemes in a satellite system. In particular, the PB-Alamouti scheme consistently outperforms the AN-aided scheme due to its efficient phase rotation capability, which provides approximately a 3.5 dB power gain, as shown in FIG. 13.

Given the passive nature of the eavesdropper, Eve, it is conceivable that Eve's SNR could eventually exceed Bob's SNR. Consequently, as shown in FIG. 14, the secrecy rate (SR) provides valuable insight into the achievable practical security level. Similarly, the PB-Alamouti scheme is observed to achieve a higher SR than the AN-aided scheme in the low-power region. Specifically, as with SC performance, it provides a power gain of approximately 3.5 dB. Meanwhile, it can be noted that both schemes exhibit nearly identical SR performance once they reach a saturation point.

FIG. 15 is a graph illustrating a secrecy capacity of the RIS-aided scheme according to the second exemplary embodiment of the present disclosure, based on a predetermined range of factor values. FIG. 16 is a graph illustrating a secrecy rate of the RIS-aided scheme according to the second exemplary embodiment of the present disclosure, based on a predetermined range of factor values.

FIGS. 15 and 16 respectively illustrate the secrecy capacity (SC) and secrecy rate (SR) performance of the second PLS approach. In this performance evaluation, it is assumed that Eve has knowledge of an average value of the reflected channel, specifically \tilde{g}_{Θ}=E_{Θ}[gᵣₑΘhₐᵣ]. The security analysis is performed under various conditions where λ is equal to or less than 1. Here, σ may be defined as σ=λσₘₐₓ, and λ may be a factor representing a proportion of a role that the RIS plays. That is, λ represents a ratio of the roles that the RIS performs in increasing the gain at Bob and inducing interference at Eve. Therefore, if A is 0.5, it indicates that the RIS is equally focused on increasing gain at Bob and causing interference at Eve.

Referring to the SC performance in FIG. 15, SC with λ=0.7 is slightly superior to the other SC values, though SC remains very similar within the range of λ from 0.5 to 0.9. Excessive increases of λ in the high transmission power region may degrade performance. Since the same power conditions are assumed for Bob and Eve, to maintain adequate security protection, the effect of interference needs to be more robust under higher power conditions.

A higher A value indicates that the RIS focuses more on amplifying Bob's channel gain rather than disrupting Eve. Therefore, under these conditions, Eve's channel fluctuations are reduced. For example, when pₜ=−40 dBW, the SC performance with λ=0.99 may be about 1 bps/Hz lower than the others.

Additionally, the SR performance in FIG. 16 shows that a higher λ value provides better performance in the low transmission power region because capacity is significantly influenced by AWGN and Bob's channel capacity. Meanwhile, in the high transmission power region, SR performance becomes more dependent on interference introduced at Eve, so performance degradation increases as λ rises.

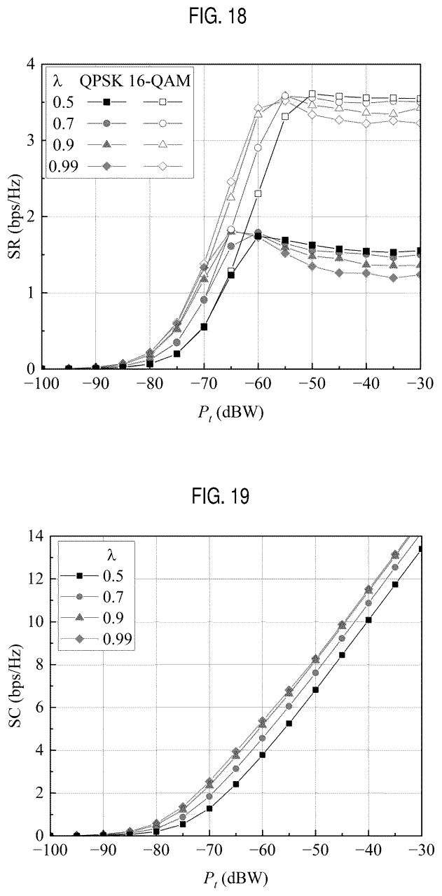

FIG. 17 is a graph comparing secrecy capacities when the AN-aided scheme and RIS scheme are integrated according to the third exemplary embodiment of the present disclosure. FIG. 18 is a graph comparing secrecy rates when the AN-aided scheme and RIS scheme are integrated according to the third exemplary embodiment of the present disclosure. FIG. 19 is a graph comparing secrecy capacities when the PB-Alamouti scheme and RIS scheme are integrated according to the third exemplary embodiment of the present disclosure, based on a predetermined range of factor values. FIG. 20 is a graph comparing secrecy rates when the PB-Alamouti scheme and RIS scheme are integrated according to the third exemplary embodiment of the present disclosure, based on a predetermined range of factor values.

FIGS. 17 to 20 illustrate the SC and SR performance of a system applying the third PLS approach of the present disclosure.

FIGS. 17 and 18 show the performance evaluation results under conditions where both the RIS and AN-aided PLS schemes are used, while FIGS. 19 and 20 show the performance evaluation results when the RIS-aided scheme is integrated with the PB-Alamouti scheme.

In this simulation, it is assumed that Eve has knowledge of the reflected channel, as shown in Equation 58.

$${g}_{Θ} = [ \begin{matrix}{E}_{Θ} ( {g}_{re} Θ {h}_{ar}^{( 1 )} ) \\ {E}_{Θ} ( {g}_{re} Θ {h}_{ar}^{( 2 )} )\end{matrix} ] \qquad [ Equation 58 ]$$

FIG. 17 shows that when using the scheme integrating the RIS and AN-aided PLS schemes, unlike in FIG. 15, the SC increases as λ increases. This is because security is provided by two sources—AN and interference—and the AN alone is already sufficient to disrupt Eve. In other words, as Bob's channel capacity increases, SC also increases. Here, σ⁽ⁱ⁾=λσₘₐₓ⁽ⁱ⁾, and λ functions to determine the balance between Bob's channel capacity and interference for Eve.

In FIG. 18, SR shows a similar trend to SC in the low-power region but exhibits inverse performance in the high-power region. This indicates that when SNR is sufficiently high, the function of the RIS needs to focus more on inducing interference at Eve rather than enhancing Bob's channel gain to strengthen security.

FIGS. 19 and 20 show the SC performance for the scheme of integrating the RIS-aided and PB-Alamouti schemes. It can be seen that these results are similar to the SC and SR performance of the system discussed earlier, as referenced in FIGS. 17 and 18, excluding the power gain achieved by the PB-Alamouti scheme.

FIG. 21 is a graph comparing secrecy capacities of the AN-aided scheme using a relay according to the fourth exemplary embodiment of the present disclosure. FIG. 22 is a graph comparing secrecy rates of the AN-aided scheme using a relay according to the fourth exemplary embodiment of the present disclosure.

Referring to FIGS. 21 and 22, in the case of AN-based PLS using a relay, it can be seen that SC and SR exhibit similar characteristics to the system with two satellites in FIGS. 13 and 14. However, in the case of PLS of the present exemplary embodiment, it can be seen that the magnitude of secrecy capacity and secrecy rate is slightly reduced due to the additional AWGN from the relay.

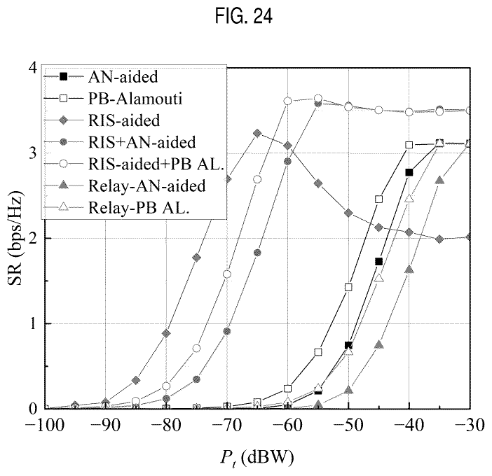

FIG. 23 is a graph illustrating secrecy capacity performance of the aforementioned exemplary embodiments according to specific factor values. FIG. 24 is a graph illustrating secrecy rate performance of the aforementioned exemplary embodiments according to specific factor values.

Referring to FIGS. 23 and 24, in the simulations for the present disclosure, λ was set to 0.7 for the second and third security enhancement approaches, and 16-QAM was used for SR estimation. The adoption of RIS shows a significant improvement in SC compared to systems without RIS, namely the first and fourth security enhancement approaches. Additionally, the adoption of the PB-Alamouti scheme further enhances SC. The SR performance also confirms that better security can be achieved by integrating the interference from RIS and AN when power is sufficiently high.

According to the aforementioned exemplary embodiments, in the first security enhancement approach, Alice may have the AN generator and the delay compensation unit. In the second security enhancement approach, the RIS controller is needed, which can provide security without burdening Alice or Bob. The third security enhancement approach, which integrates the first and second approaches, enhances security compared to applying either scheme individually. The fourth security enhancement approach shows the lowest power efficiency but can serve as a crucial PLS scheme when the relay is used to improve signal strength, allowing for a performance trade-off between SR and signal strength at Bob.

According to the four aforementioned security enhancement approaches, various levels of security enhancement can be provided across different system configurations. If reducing system complexity is a priority, Alice may be equipped with the delay compensation unit and the AN generator. However, this scheme may require an expensive power amplifier capable of handling power fluctuations caused by AN. Additionally, when utilizing RIS technology, there is no need to modify Alice's system configuration. Furthermore, if additional security enhancement is required, integrating RIS with the AN-aided scheme may be considered. In this case, the system may be configured to use the PB-Alamouti scheme instead of the AN-aided Alamouti code, thereby further improving power efficiency and security.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A security enhancement method, performed by a controller controlling a reconfigurable intelligent surface (RIS), comprising:
selecting first RIS elements for a first signal transmitted between a transmitter and a first receiver that is a legitimate receiver, the first RIS elements including at least part of elements of the RIS;
transmitting the first signal to the first receiver using the first RIS elements; and
dynamically rendering a channel with another receiver or an eavesdropper without changing a channel with the first receiver during a channel coherence time between the transmitter and the first receiver, by changing phase(s) of at least part of the first RIS elements at least once during the channel coherence time.

2. The security enhancement method according to claim 1, wherein the first signal includes reference signals or pilot signals for channel estimation.

3. The security enhancement method according to claim 2, wherein an interval of the reference signals or pilot signals is set to be smaller than the channel coherence time for the first signal.

4. The security enhancement method according to claim 2, further comprising: estimating a channel capacity of the first RIS elements, wherein the estimated channel capacity is a maximum channel capacity of the first RIS elements.

5. The security enhancement method according to claim 4, further comprising: determining a channel capacity to be actually used for the first RIS elements by multiplying the maximum channel capacity by a weight having a positive real value less than 1.

6. The security enhancement method according to claim 5, wherein the weight is selected as a value equal to or greater than 0.5 and equal to or less than 0.9.

7. The security enhancement method according to claim 4, wherein the maximum channel capacity is determined based on an optimum accumulated channel from the transmitter to the first receiver.

8. The security enhancement method according to claim 7, further comprising: determining an accumulated channel with multiple roots from the transmitter to the first receiver.

9. The security enhancement method according to claim 2, wherein the rendering is performed at least once during a reception duration of the first signal, when the first receiver operates for the channel estimation.

10. The security enhancement method according to claim 1, further comprising: estimating a channel capacity of the first RIS elements, wherein the channel capacity is estimated as a channel capacity when an inverse bandwidth of a baseband signal at the first receiver is equal to or less than a half of the channel coherence time.

11. A security enhancement device using a reconfigurable intelligent surface (RIS), comprising:
a memory storing at least one instruction; and
a processor executing the at least one instruction,
wherein the at least one instruction causes the processor to perform:
selecting first RIS elements for a first signal transmitted between a transmitter and a first receiver that is a legitimate receiver, the first RIS elements including at least part of elements of the RIS;
transmitting the first signal to the first receiver using the first RIS elements; and
dynamically rendering a channel with another receiver or an eavesdropper without changing a channel with the first receiver during a channel coherence time between the transmitter and the first receiver, by changing phase(s) of at least part of the first RIS elements at least once during the channel coherence time.

12. The security enhancement device according to claim 11, wherein the first signal includes reference signals or pilot signals for channel estimation.

13. The security enhancement device according to claim 12, wherein an interval of the reference signals or pilot signals is set to be smaller than the channel coherence time for the first signal.

14. The security enhancement device according to claim 12, wherein the at least one instruction causes the processor to perform: estimating a channel capacity of the first RIS elements, wherein the estimated channel capacity is a maximum channel capacity of the first RIS elements.

15. The security enhancement device according to claim 14, wherein the at least one instruction causes the processor to perform: determining a channel capacity to be actually used for the first RIS elements by multiplying the maximum channel capacity by a weight having a positive real value less than 1.

16. The security enhancement device according to claim 15, wherein the weight is selected as a value equal to or greater than 0.5 and equal to or less than 0.9.

17. The security enhancement device according to claim 14, wherein the maximum channel capacity is determined based on an optimum accumulated channel from the transmitter to the first receiver.

18. The security enhancement device according to claim 17, wherein the at least one instruction causes the processor to perform: determining an accumulated channel with multiple roots from the transmitter to the first receiver.

19. The security enhancement device according to claim 12, wherein the rendering is performed at least once during a reception duration of the first signal, when the first receiver operates for the channel estimation.

20. The security enhancement device according to claim 11, wherein the at least one instruction causes the processor to perform: estimating a channel capacity of the first RIS elements, wherein the channel capacity is estimated as a channel capacity when an inverse bandwidth of a baseband signal at the first receiver is equal to or less than a half of the channel coherence time.
